(19) United States
(12) Patent Application Publication
(10) Pub. No.: US 2019/0318641 A1
(43) Pub. Date: Oct. 17, 2019

(54) SYSTEMS AND METHODS FOR COMPUTER GUIDED COACHING

(71) Applicant: ActiFi, Inc., Plymouth, MN (US)

(72) Inventor: Spenser Segal, Plymouth, MN (US)

(21) Appl. No.: 16/248,237

(22) Filed: Jan. 15, 2019

Related U.S. Application Data
(63) Continuation of application No. 14/216,735, filed on Mar. 17, 2014, now abandoned.
(60) Provisional application No. 61/800,969, filed on Mar. 15, 2013.

(51) Int. Cl. G09B 5/02

(52) U.S. Cl. CPC G09B 5/02

(57) ABSTRACT

A computerized system and method provides for computer assisted coaching and education of individuals seeking to enhance their performance or reach a desired goal. According to one example embodiment, goals data units are provided that work with a goal coaching engine to provide computer guided assistance in achieving a goal. Goals may include strategies, strategies may include tactics, and tactics may include tasks. In one embodiment, communication with a coaching recipient is optionally performed through communication services used by the recipient for other purposes, such as e-mail, text messaging, social media messaging, and instant messaging.

### CLAIM OF PRIORITY

This application is a continuation of U.S. patent application Ser. No. 14/216,735, filed on Mar. 17, 2014, which claims the benefit of priority to U.S. Provisional Application Ser. No. 61/800,969, filed on Mar. 15, 2013, which applications are hereby incorporated by reference herein in their entireties.

### TECHNICAL FIELD

This application relates generally to data processing within a network-based coaching system, and more specifically to systems and methods for computer assisted or guided coaching of an individual to achieve a desired goal.

### BACKGROUND

Online education is growing rapidly. Many universities now offer or have plans to develop its own set of MOOCs (Massive Open Online Courses), and there are now hundreds of MOOCs from universities all over the world. These MOOCs have already served millions of students, enabling anyone with an Internet connection to receive a world-class education. Similarly, online or more generally computer assisted or guided coaching outside the academic realm also holds great promise to enhance the skills of the workforce in ever more efficient and effective ways. Unfortunately, in environments where the principal purpose of the education or coaching is not academic achievement and particularly where the need to improve performance is not acute, traditional online educational approaches may be ineffective for most individuals.

### BRIEF DESCRIPTION OF THE DRAWINGS

Some embodiments are illustrated by way of example and not limitation in the figures of the accompanying drawings in which:

FIGS. 1-1 to 1-8 illustrate various embodiments of the method and apparatus, according to an example embodiment.

FIGS. 2-1 to 2-50 illustrate various GUI interfaces, systems and methods, according to an example embodiment.

FIG. 3 is a block diagram illustrating an environment for operating a mobile device, according to an example embodiment.

FIG. 4 is a block diagram illustrating a mobile device, according to an example embodiment.

FIG. 5 is a block diagram illustrating a network-based system for delivering coaching content and interacting with coaching recipients, according to an example embodiment.

FIG. 6 is a diagrammatic representation of a machine in the example form of a computer system within which a set of instructions for causing the machine to perform any one or more of the methodologies discussed herein may be executed.

### DEFINITIONS

Real-time—For the purposes of this specification and the associated claims, the term “real-time” is used to refer to calculations or operations performed on-the-fly as events occur or input is received by the operable system. However, the use of the term “real-time” is not intended to preclude operations that cause some latency between input and response, so long as the latency is an unintended consequence induced by the performance characteristics of the machine.

User—For the purposes of this specification and the appended claims, the term “user” generally refers to any person who accesses a coaching website, server or system, uses a communications device or service communicating with the coaching server or system, or engages in any other electronic interaction with the coaching system.

### DETAILED DESCRIPTION

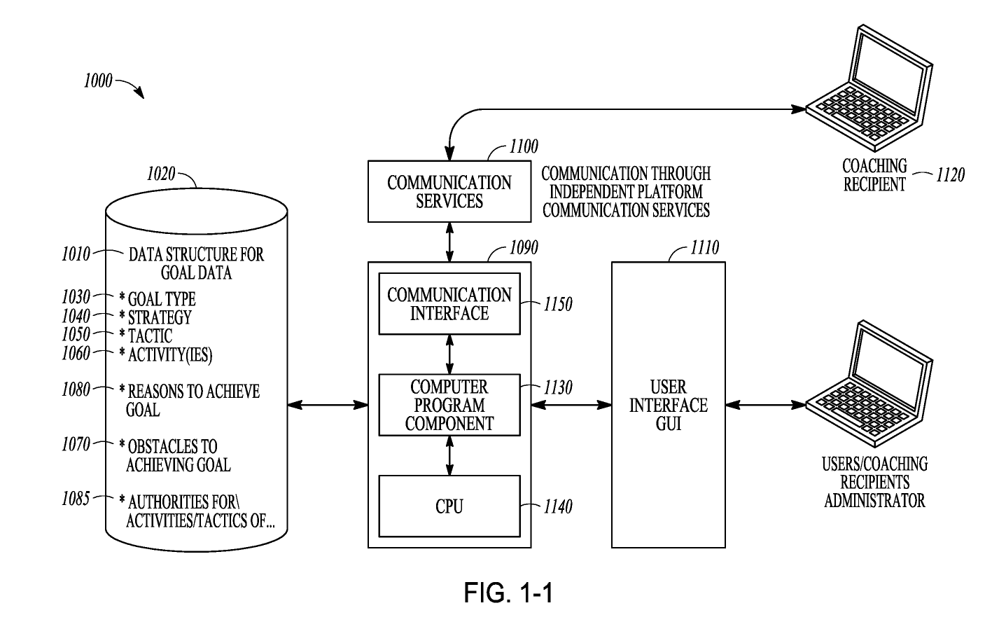

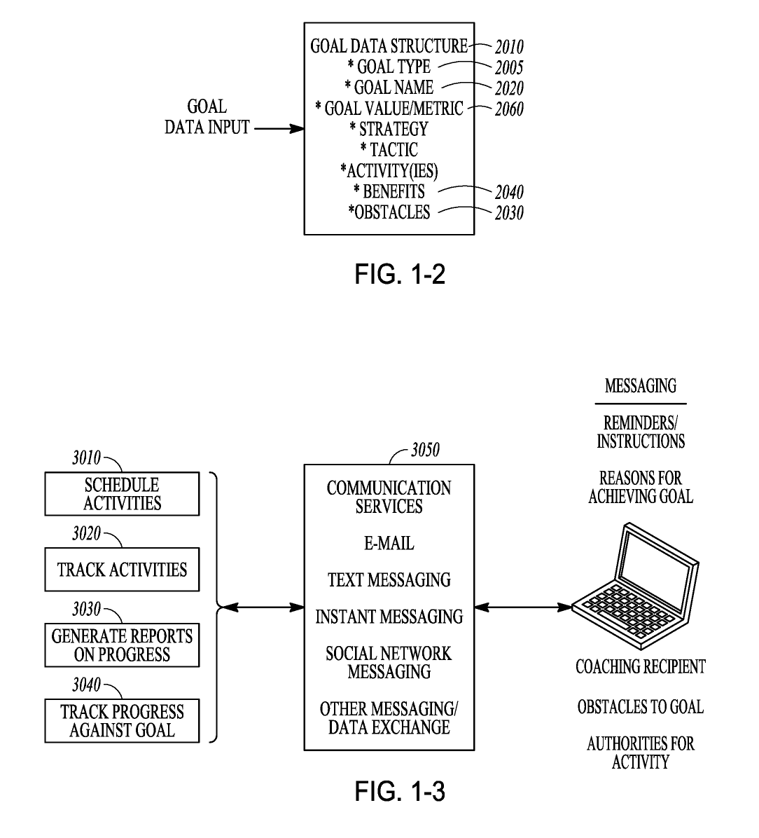

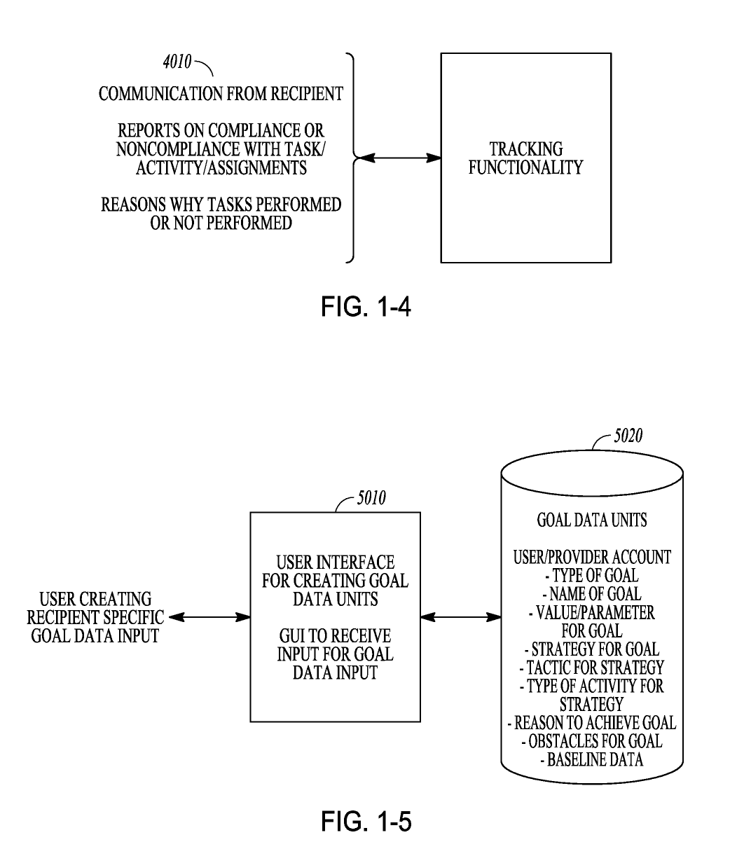

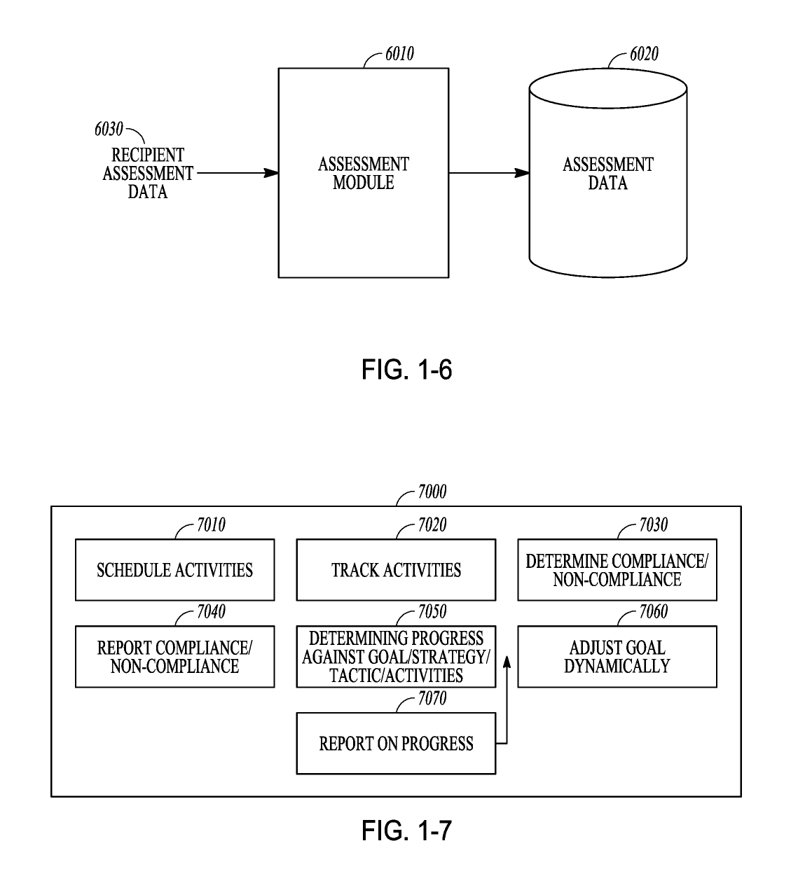

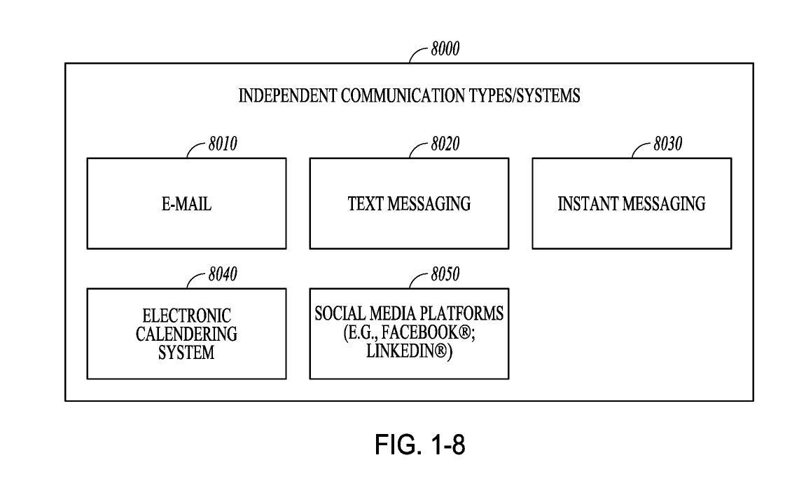

Example systems and methods for providing online or computer assisted or guided coaching are described. In the following description, for purposes of explanation, numerous specific details are set forth in order to provide a thorough understanding of example embodiments. It will be evident, however, to one skilled in the art that the present invention may be practiced without these specific details. Referring now to FIG. 1-1, there is illustrated an example overview of the computer guided coaching system 1000 according to one example embodiment. In this example embodiment, there is provided a computerized coaching system for creating, structuring, storing, and tracking goal information, and providing coaching content and interactivity with a user. In one example embodiment, coaching is delivered to a recipient based on a goal that the recipient seeks to achieve. As used herein, the term “goal” defines a “general” or “high level” result a coaching recipient seeks to attain, wherein the result can be achieved in a multitude of different ways. In general, the system described herein provides a data structure 1010, data storage 1020, computer programs and computing system 1090, user interface and communications with system users 1100 and 1110 and the coaching recipient 1120 that breaks down a high level goal into activities that the coaching recipient can perform in relatively short periods of time. According to one examples embodiment, a “short” period of time is approximately one hour of time or less. In one example a user interface and data structure, there is provided a hierarchy that includes: a) a goal 1030, b) a strategy to achieve the goal 1040, c) objectives 1050, also referred to as tactics, to achieve the strategy, d) and activities 1060, typically defined as tasks, to achieve the objectives. In addition, in this example embodiment, the data structure further includes: a) one or more obstacles to achieving the goal 1070 and b) one or more personal benefits 1080, i.e. reasons, for achieving the goal. Further, the data structure further includes one or more sources of authority 1085 for the effectiveness of performing one or more of the activities associated with a strategy/tactic. Still further, the data structure includes one or more reasons why a recipient of the coaching may not be able to complete one or more of the activities, such as, but not limited to, an inability to find the time, lack of knowledge or skills or resource needed to perform the activity, a lack of motivation to perform the activity, or a health problem interfering with the ability to perform the activity.

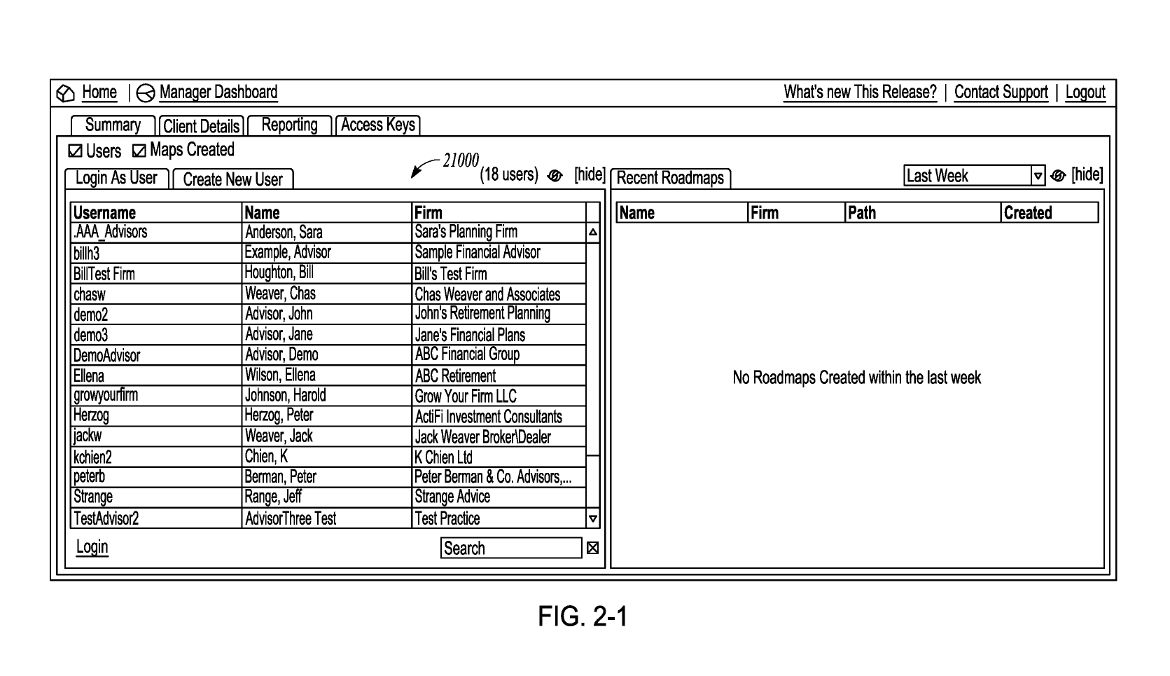

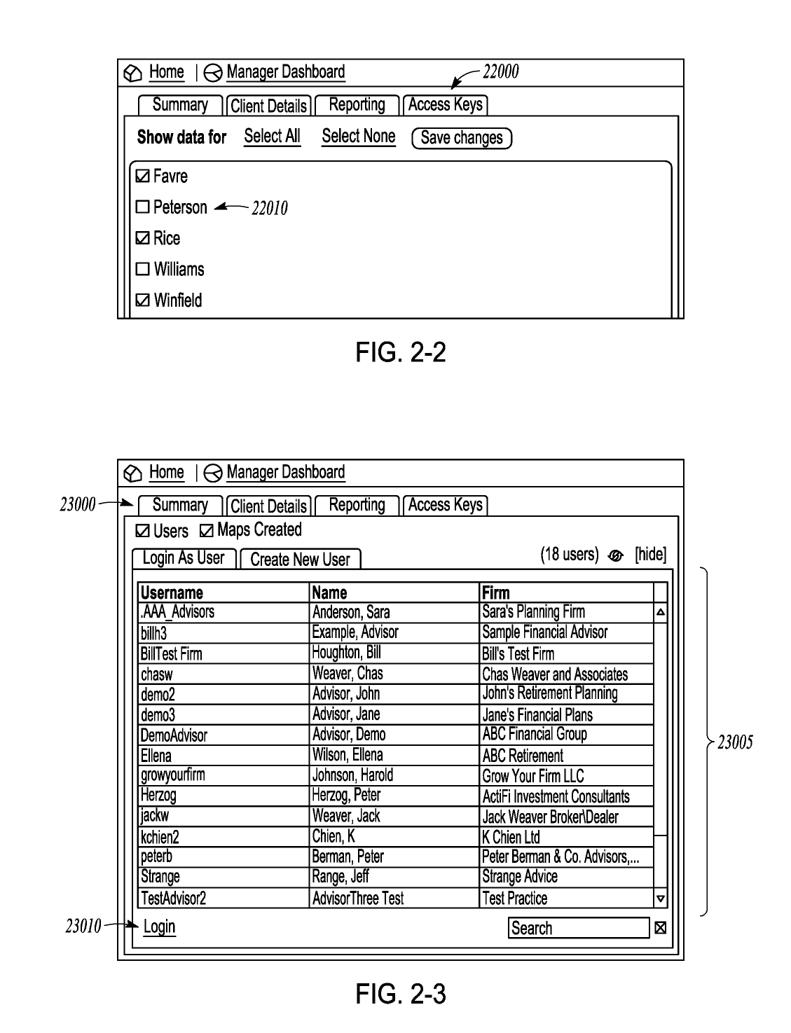

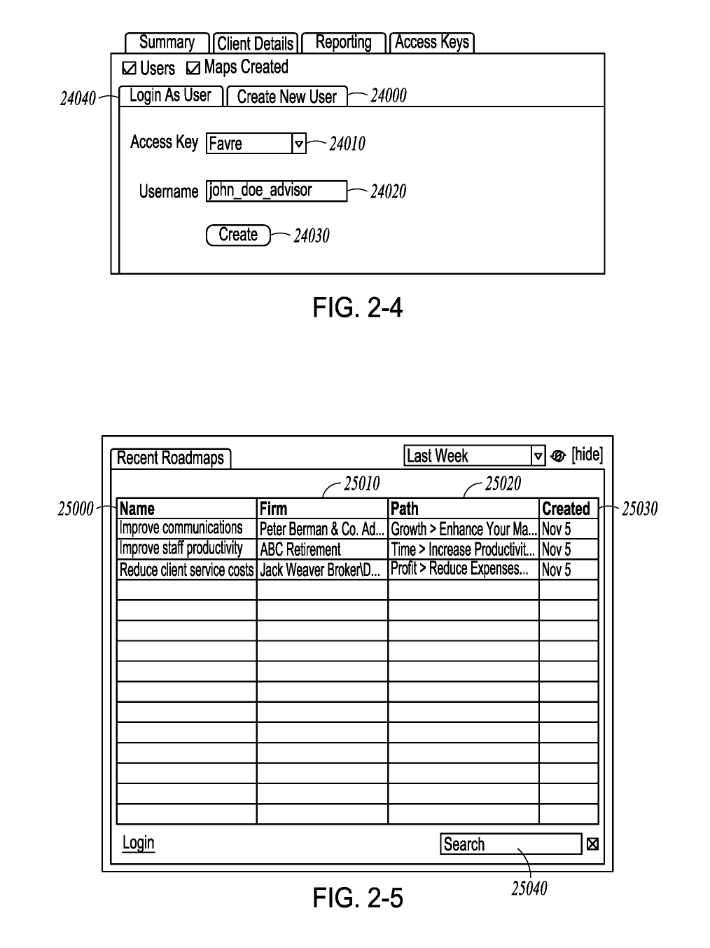

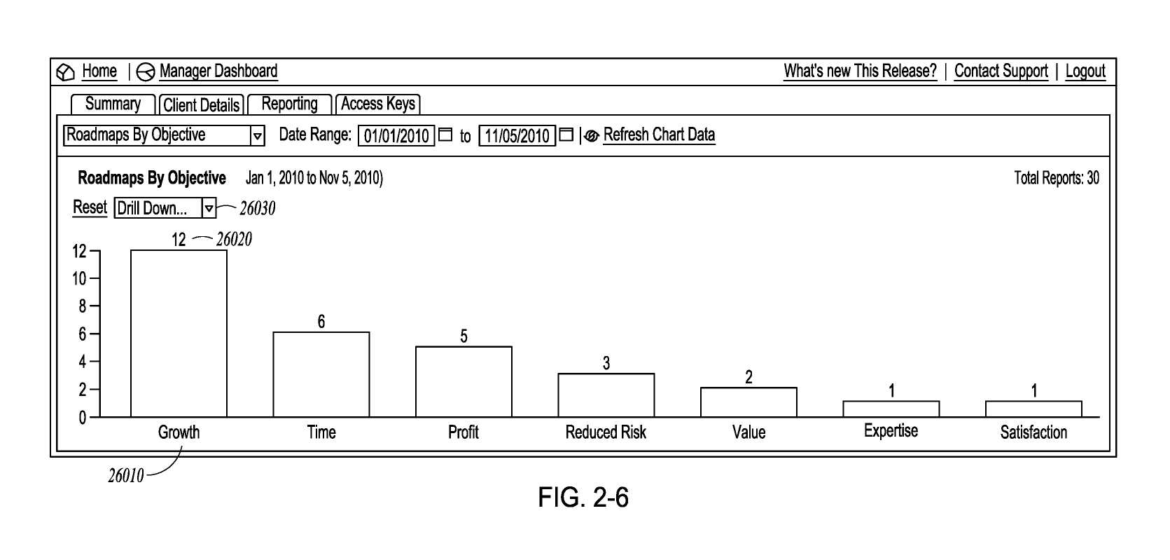

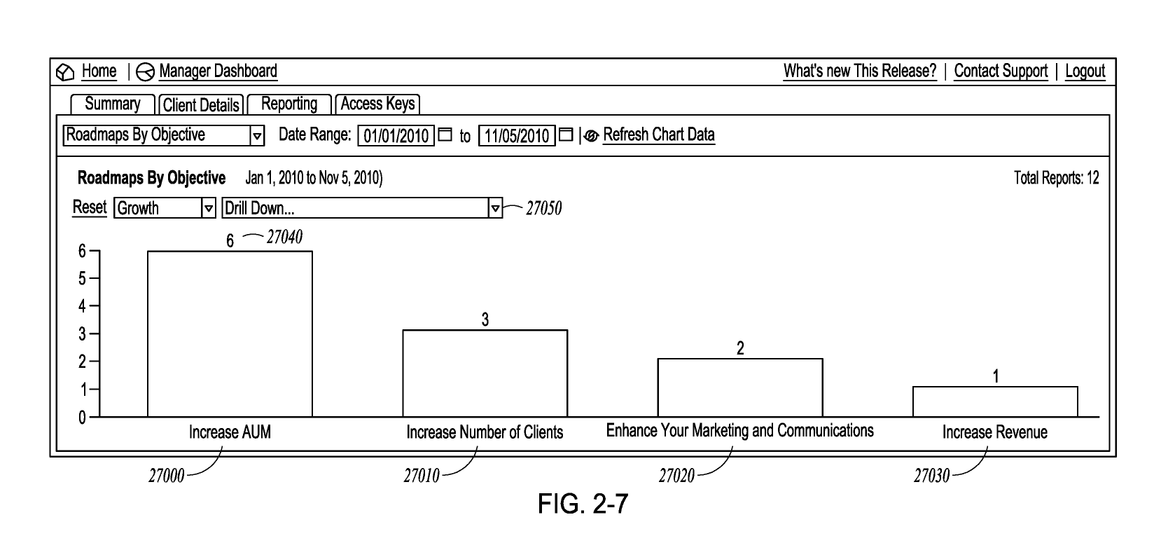

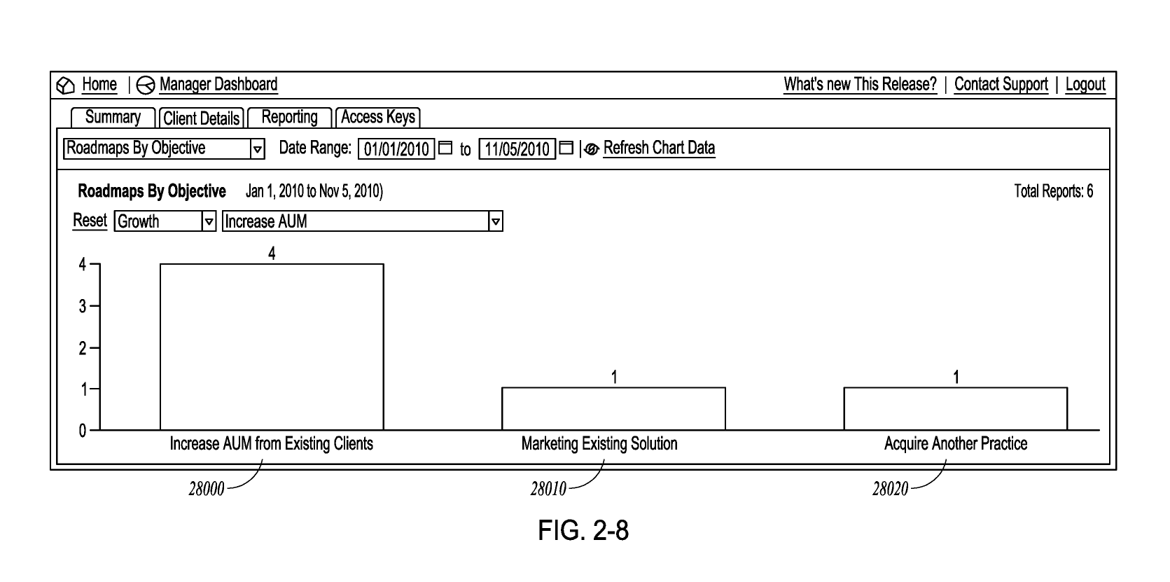

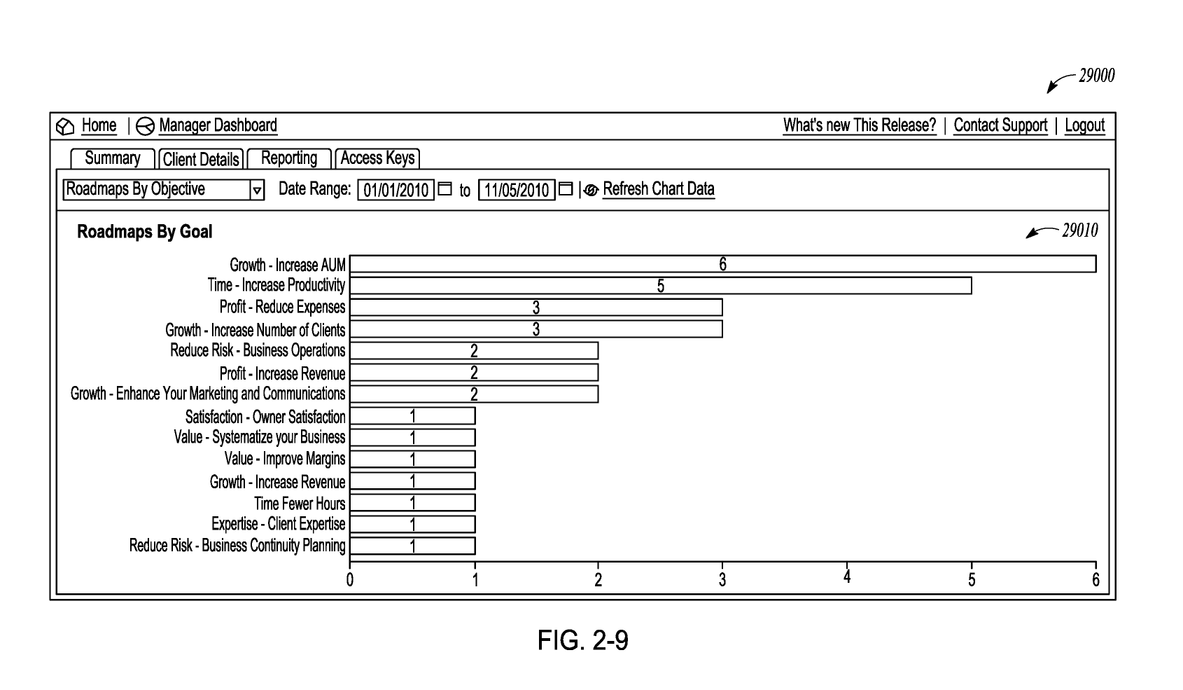

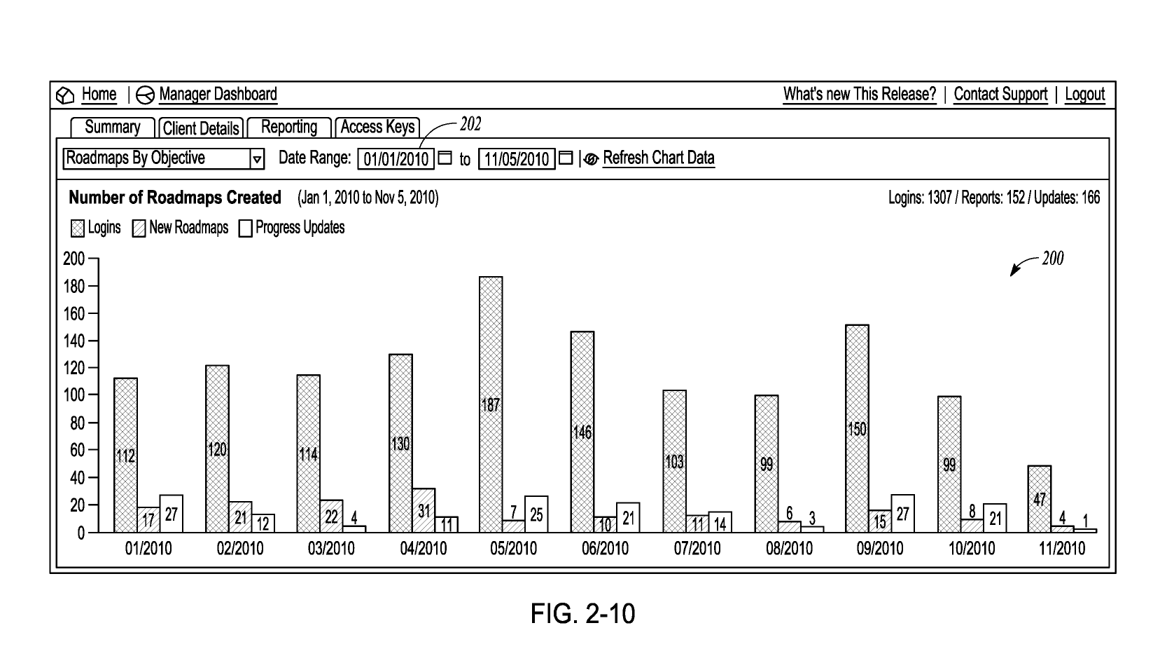

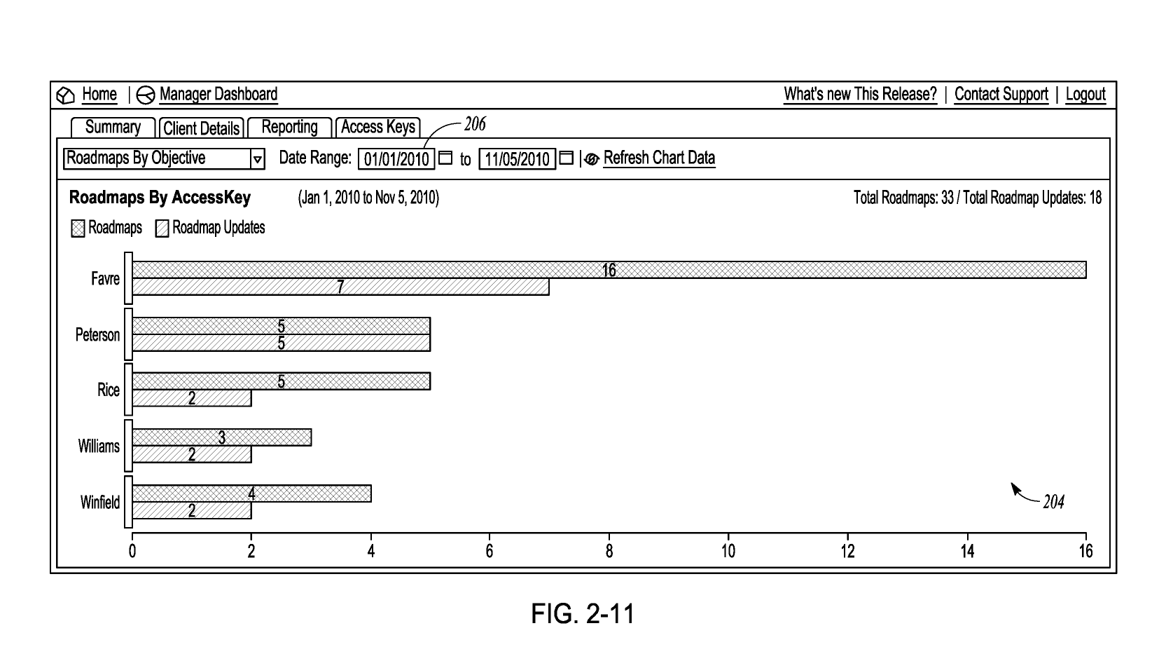

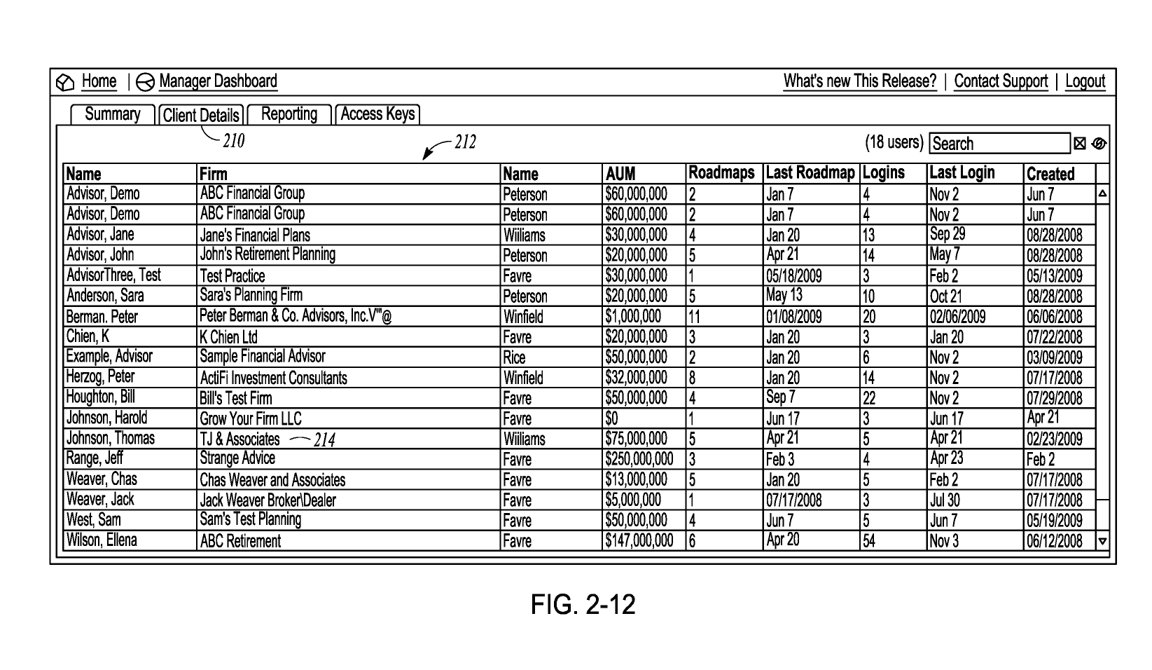

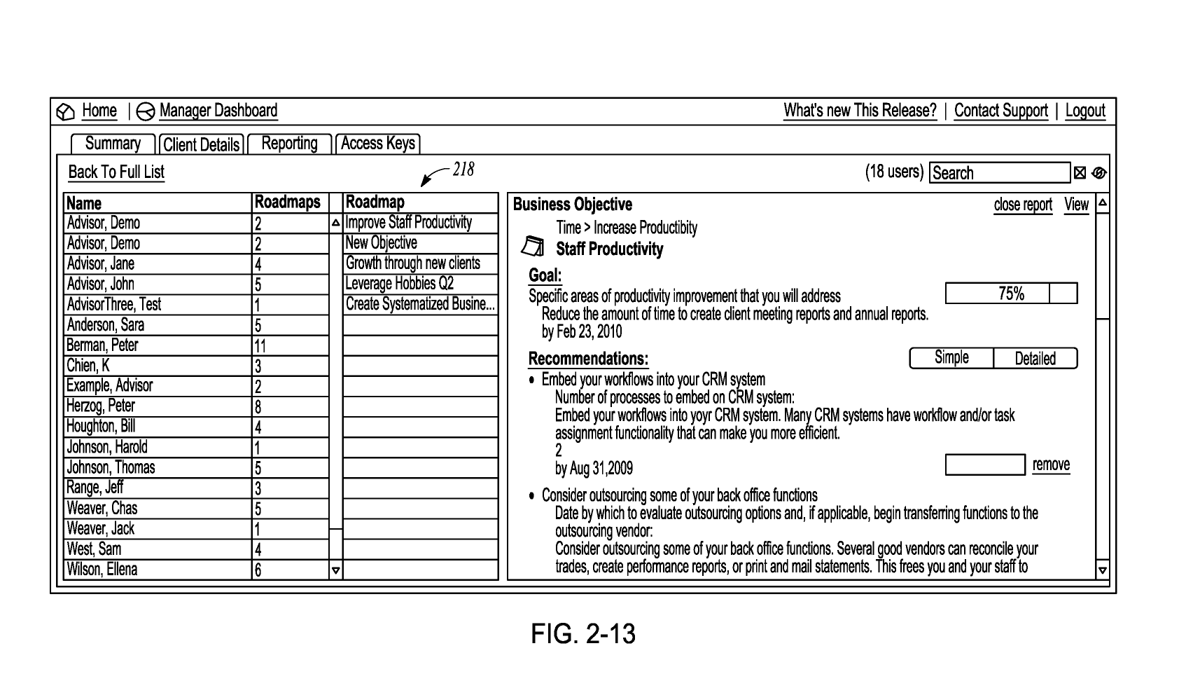

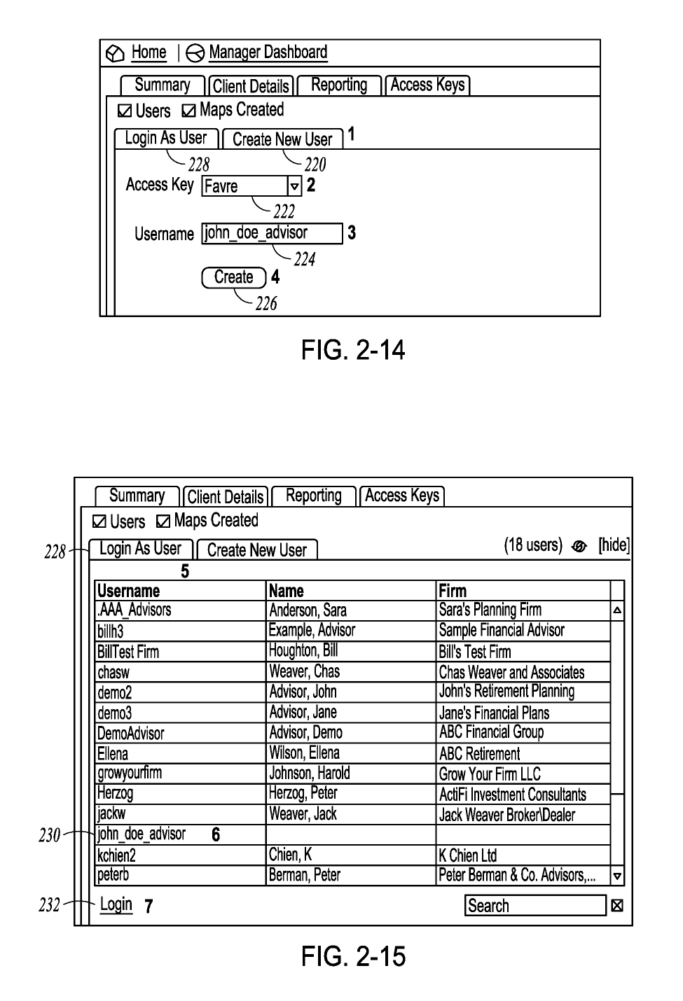

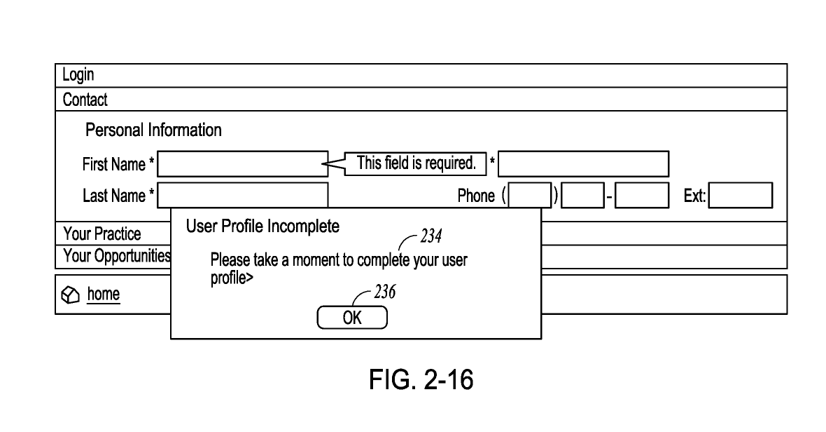

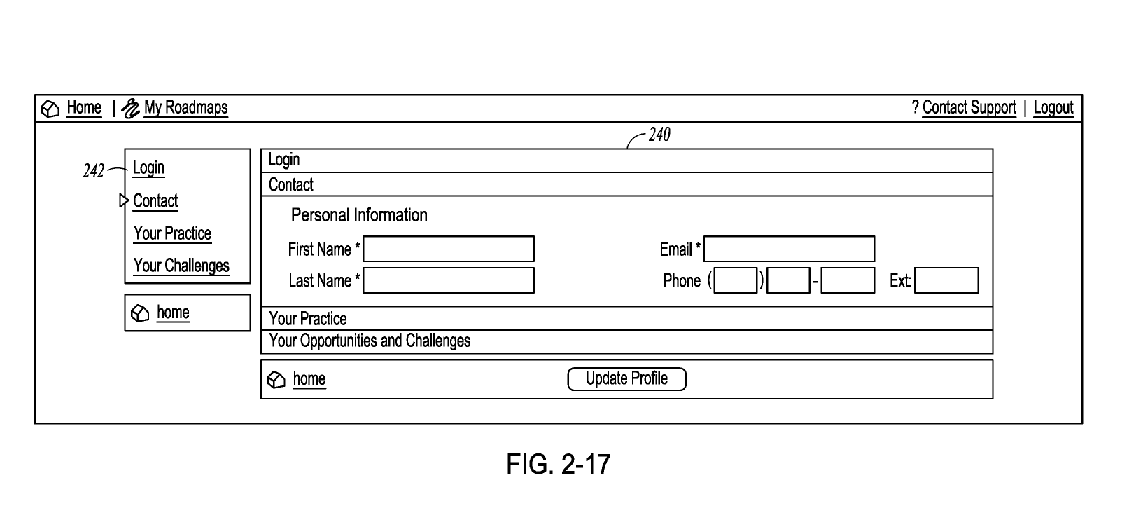

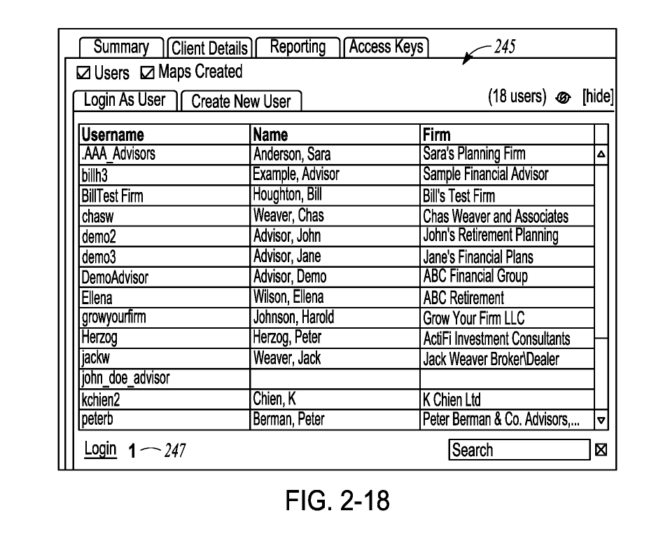

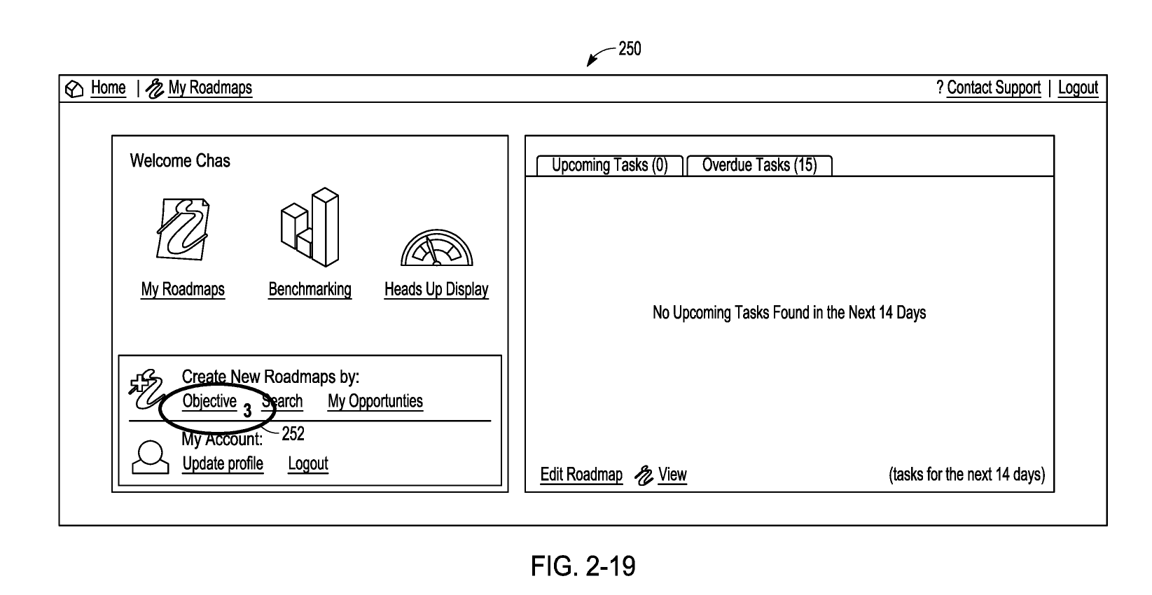

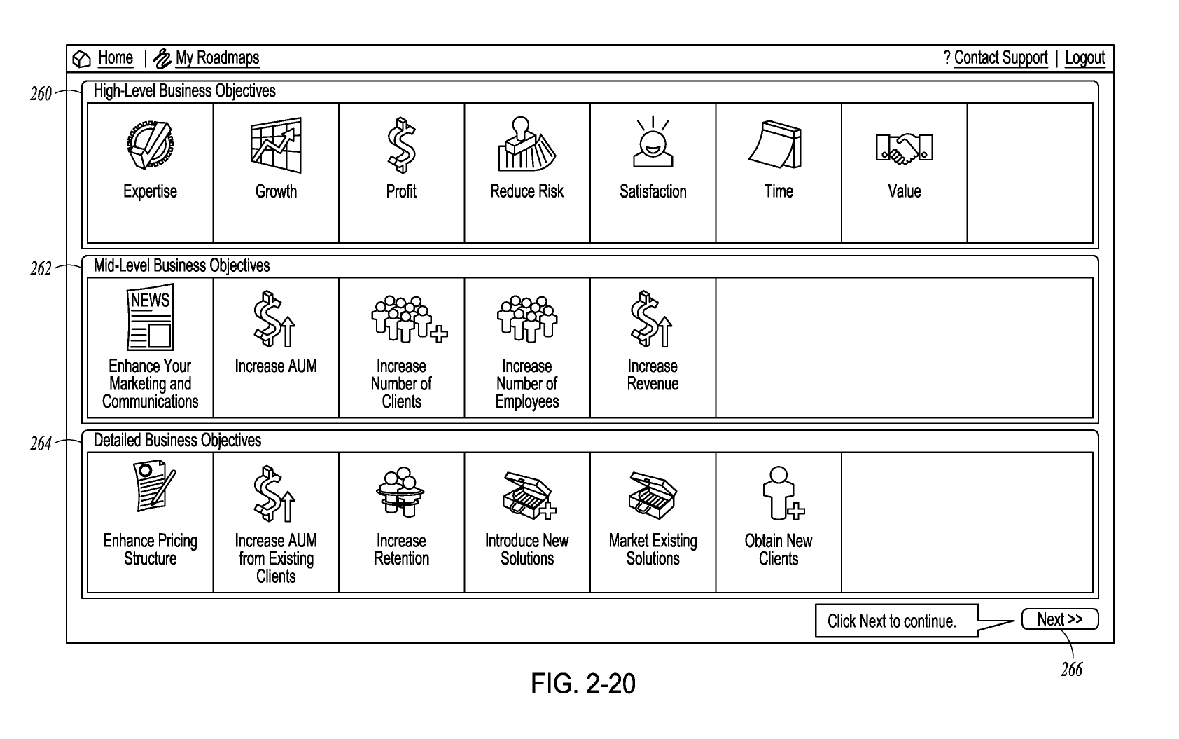

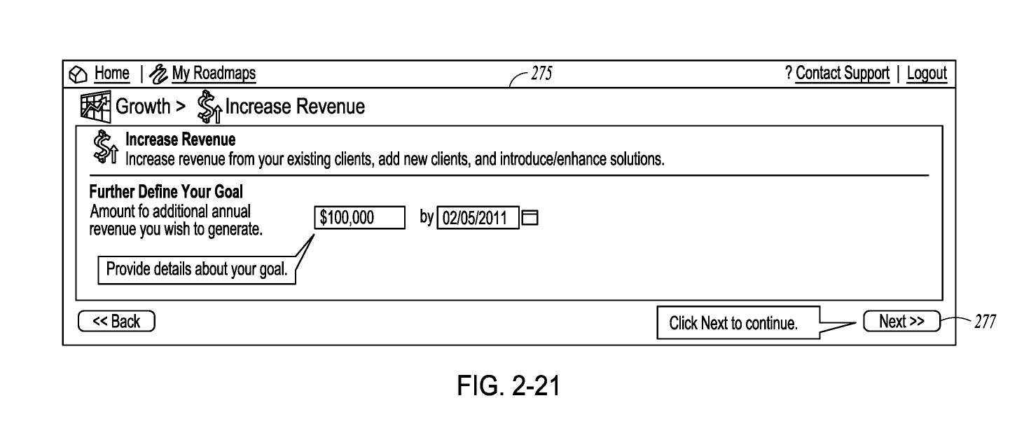

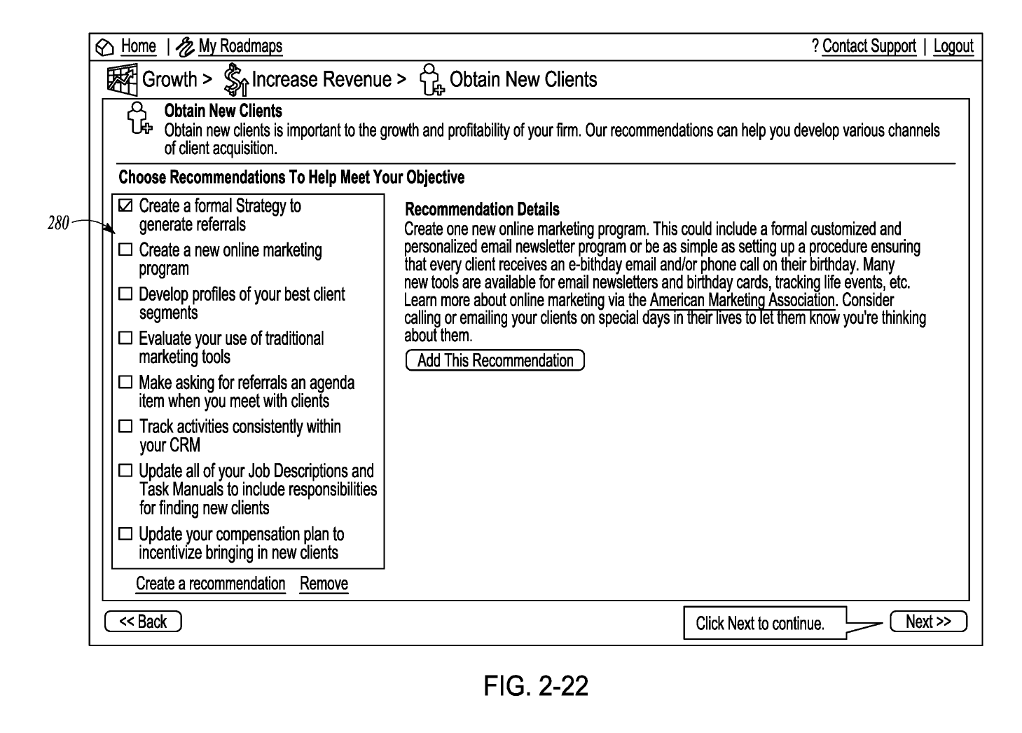

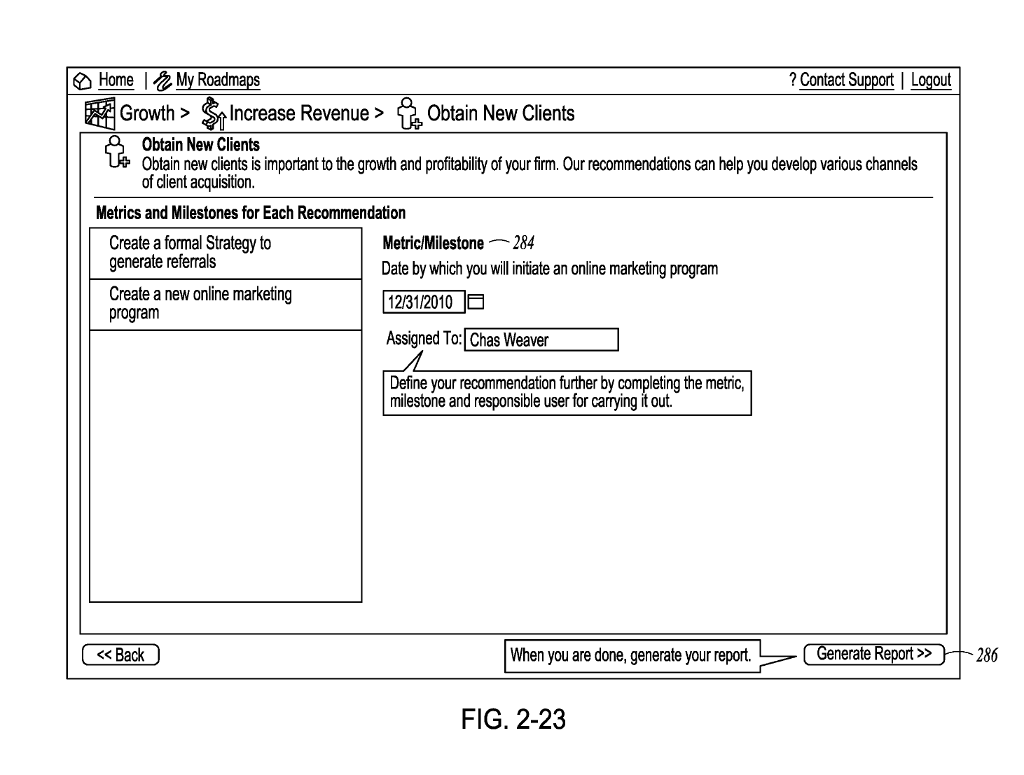

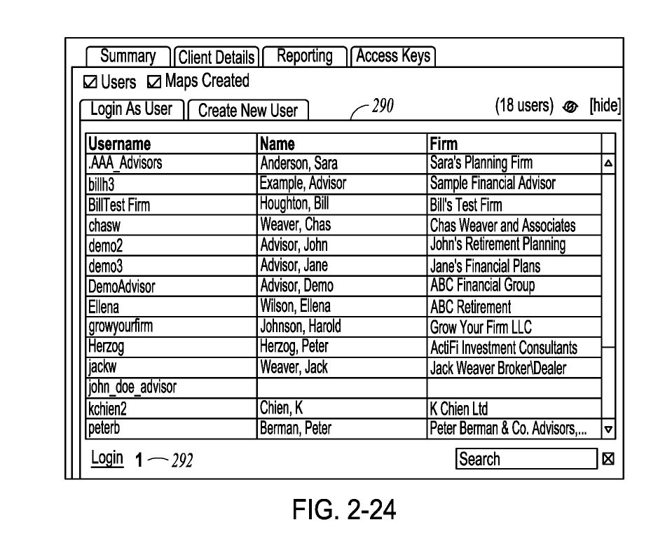

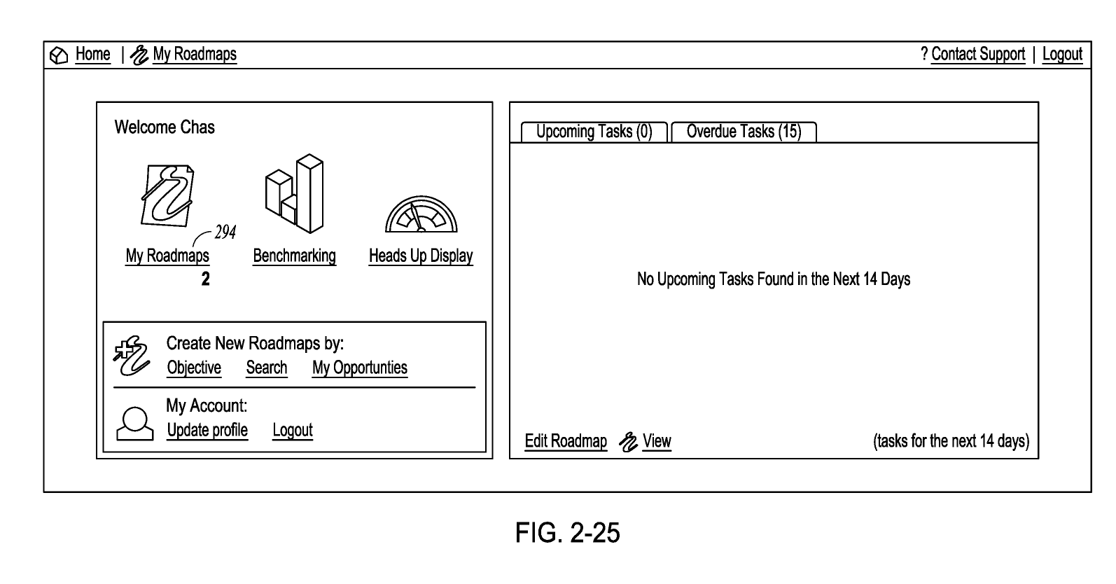

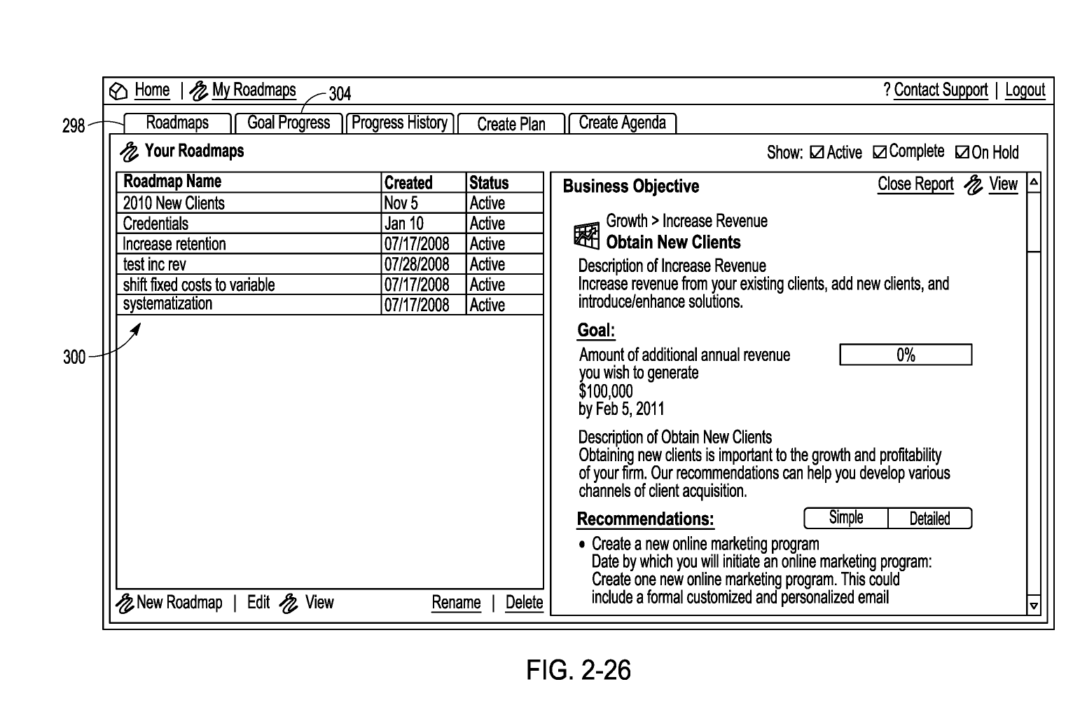

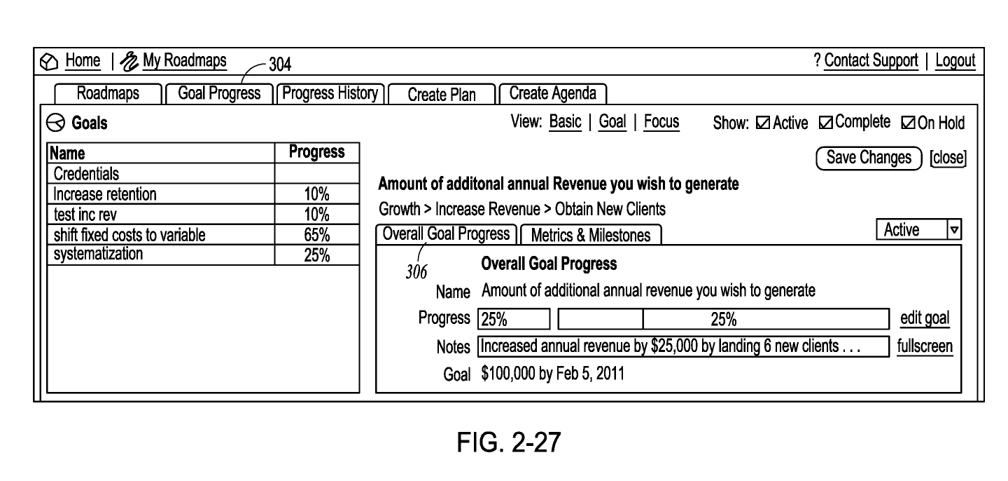

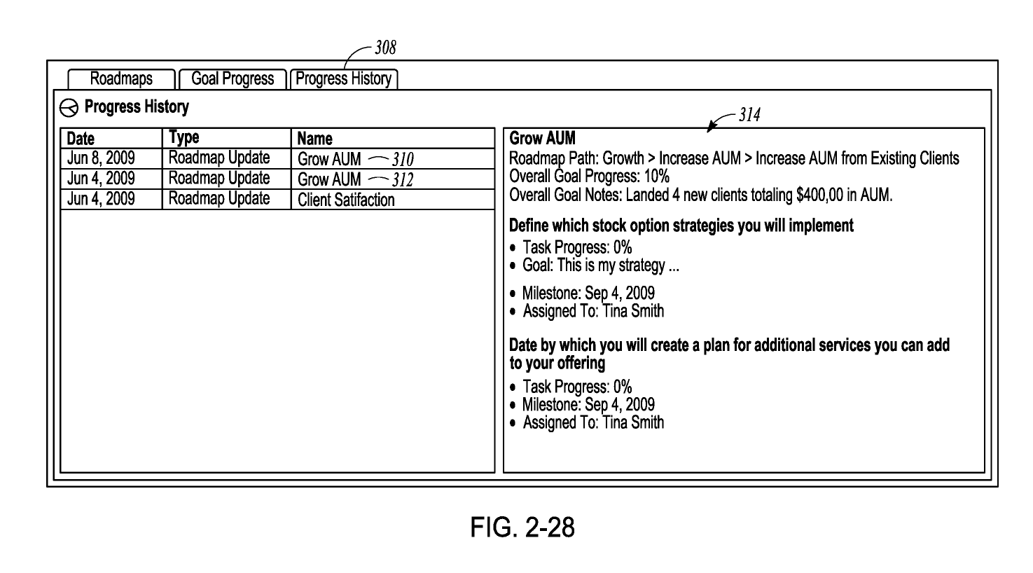

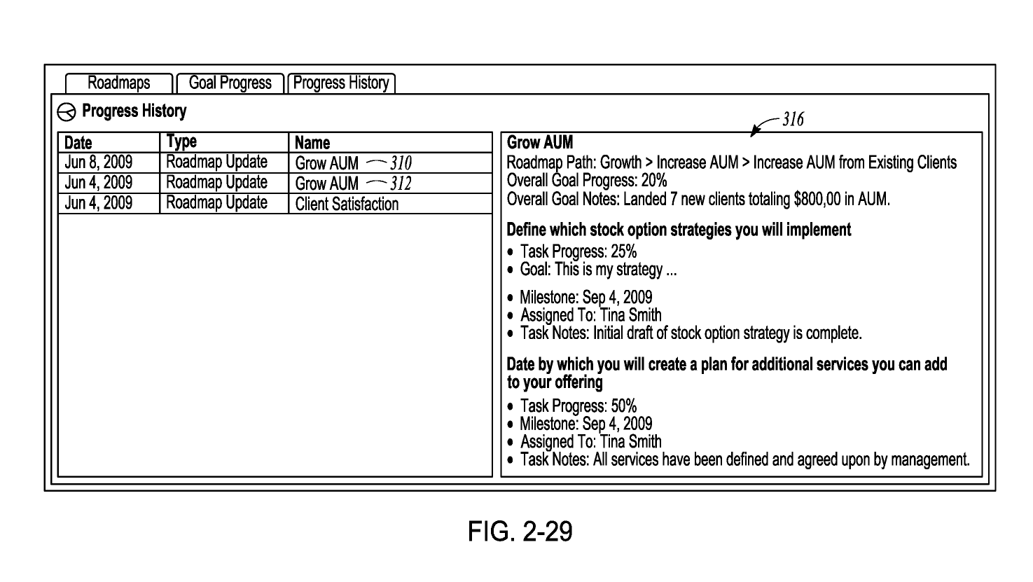

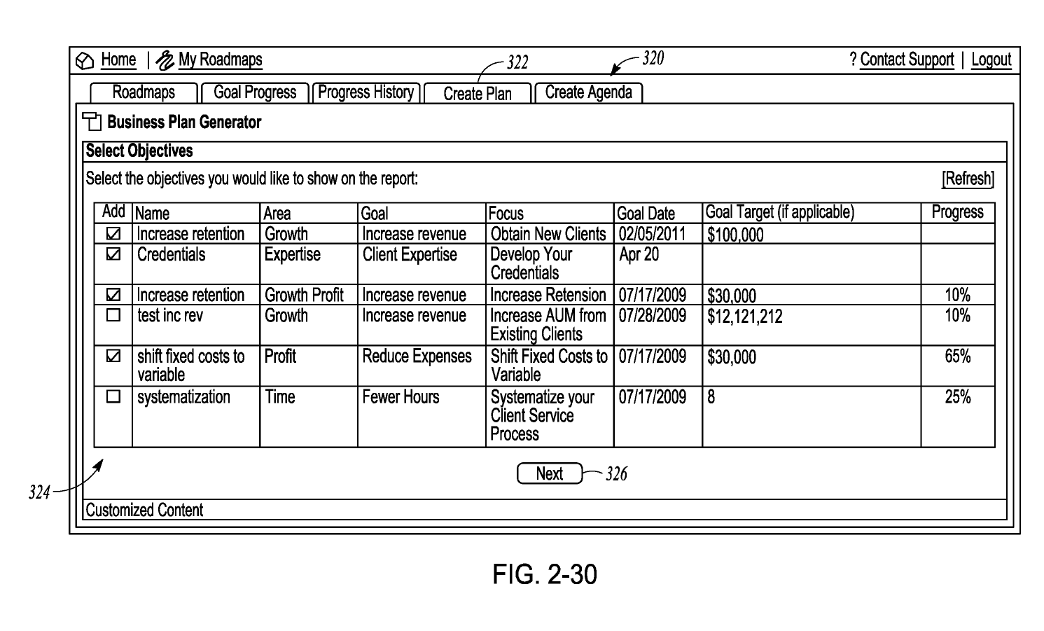

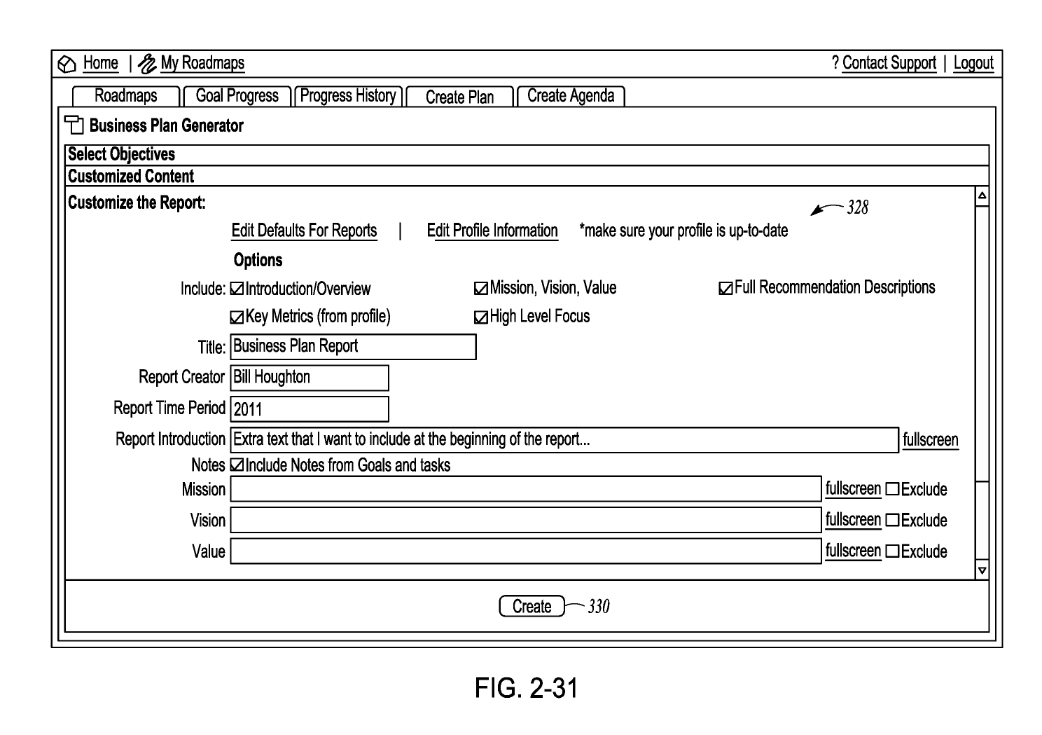

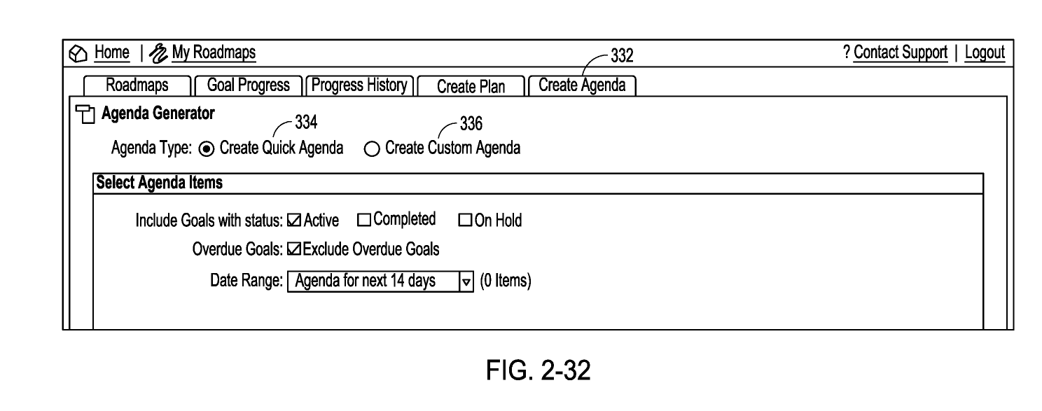

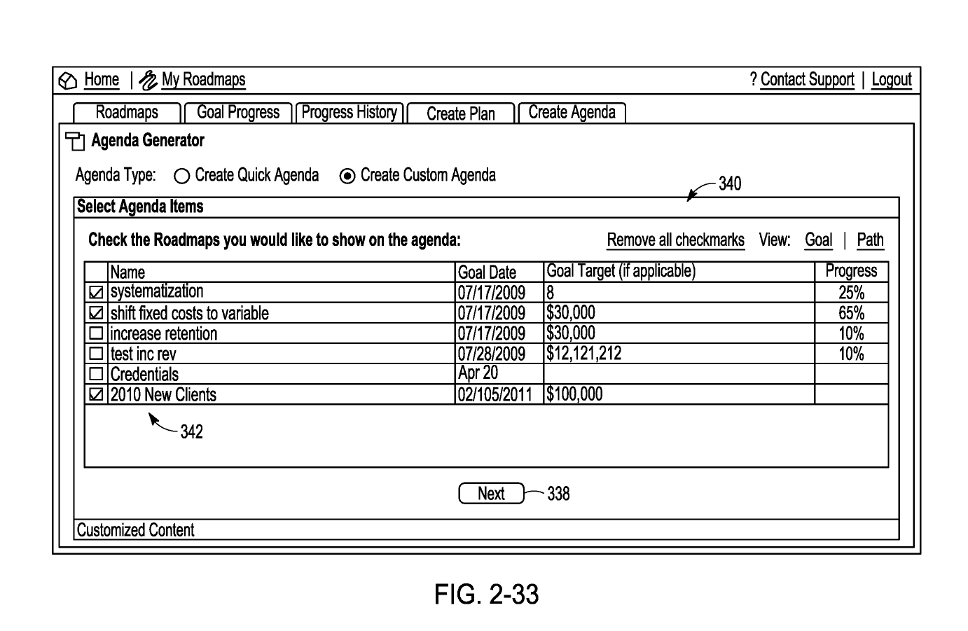

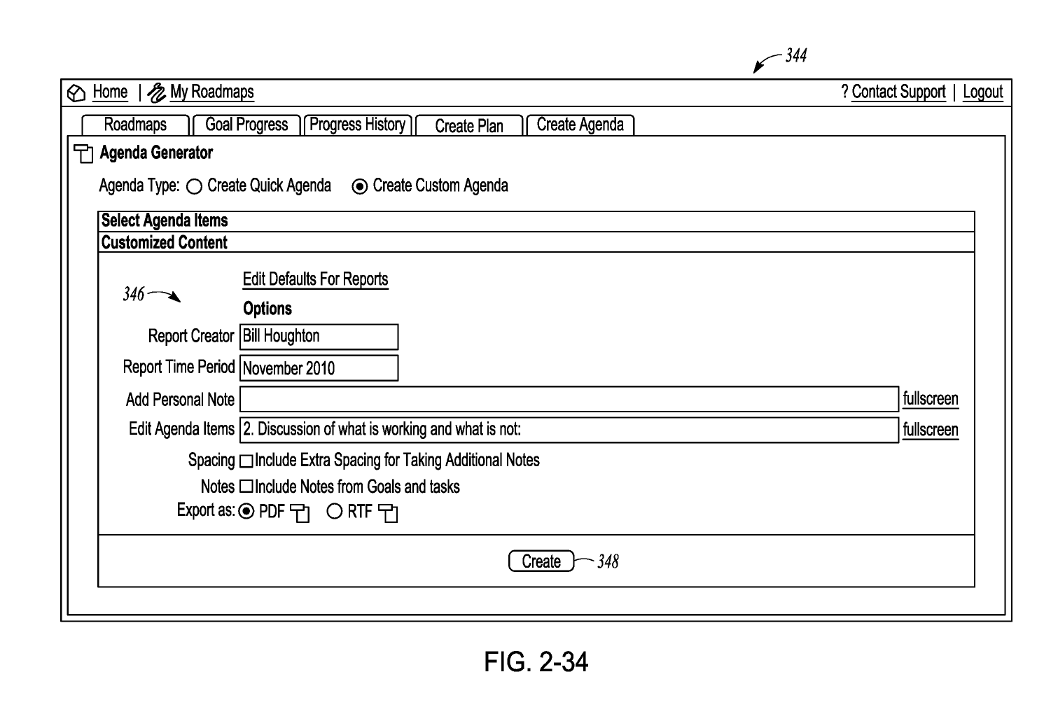

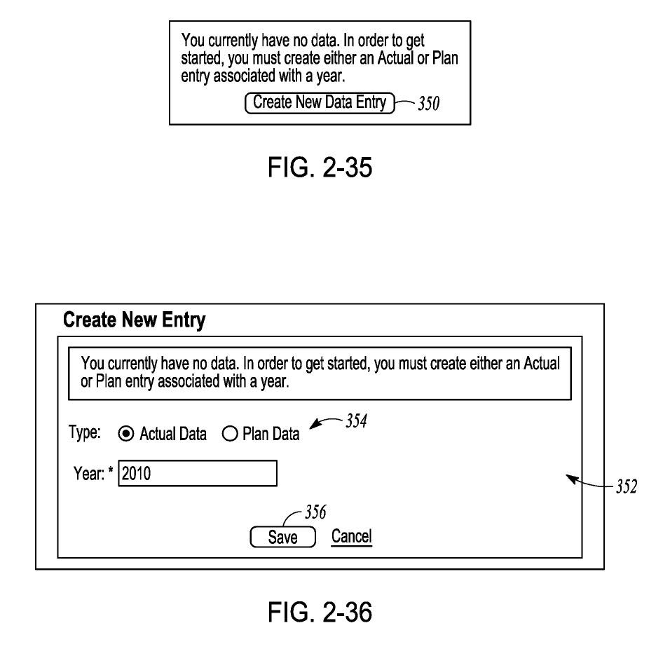

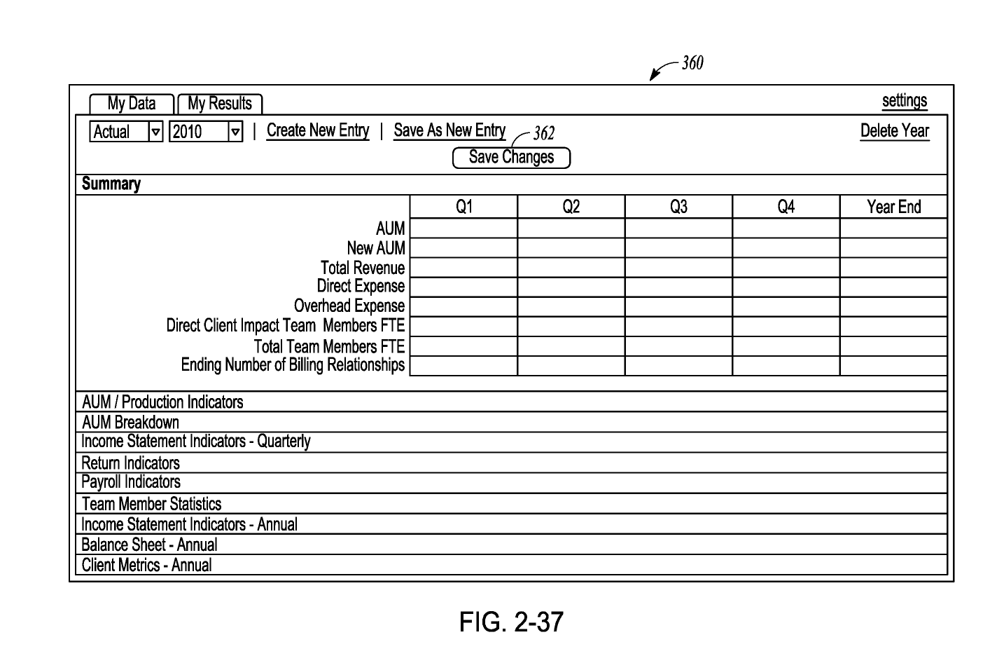

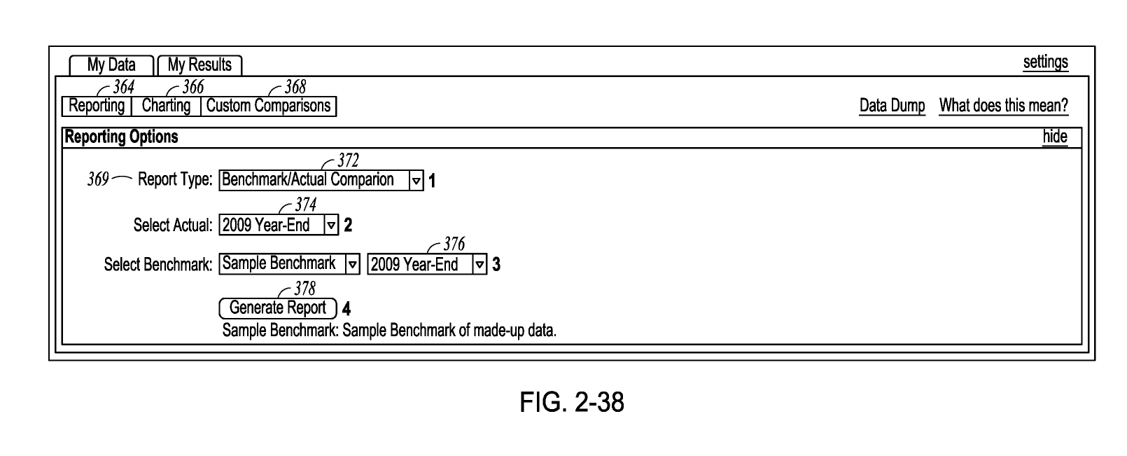

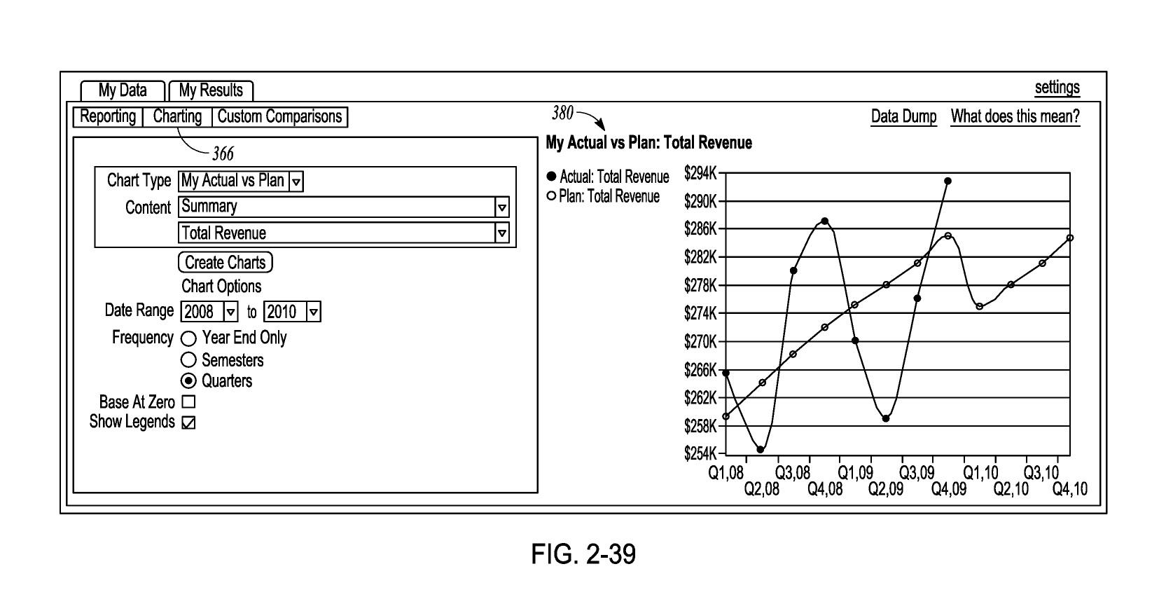

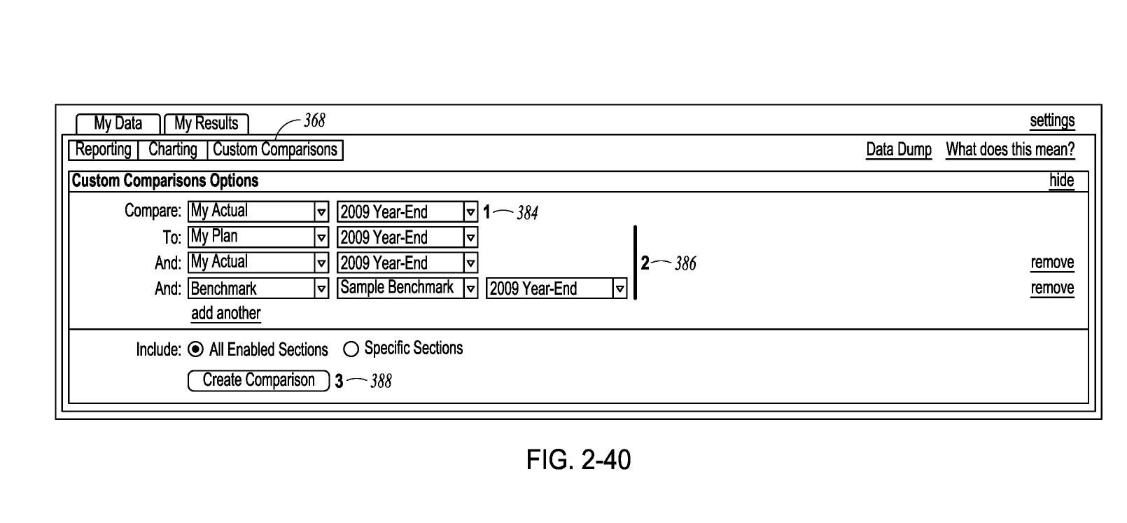

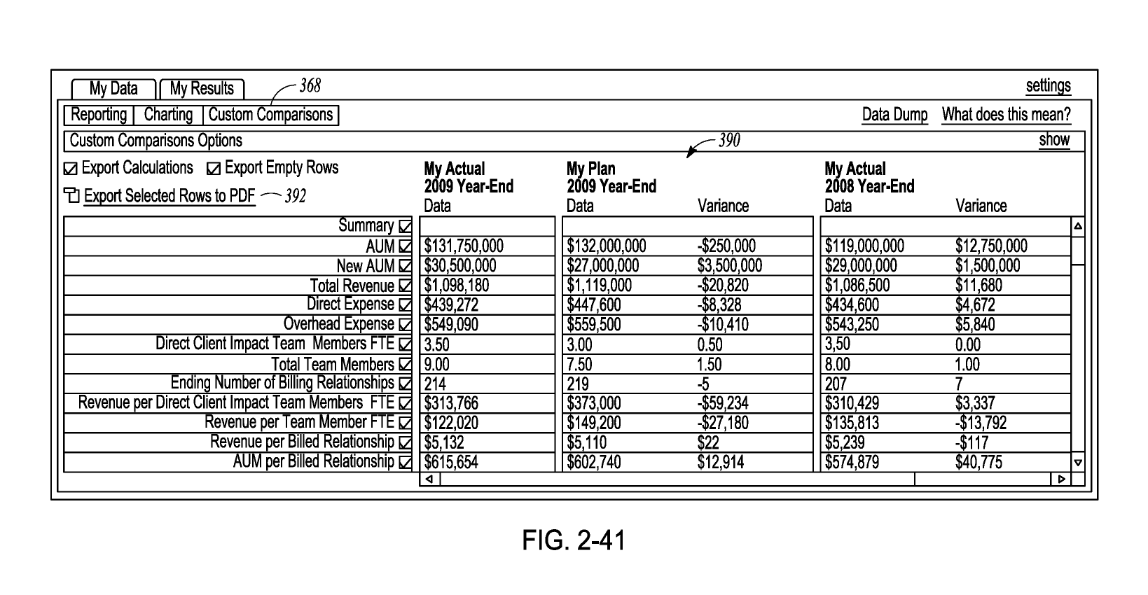

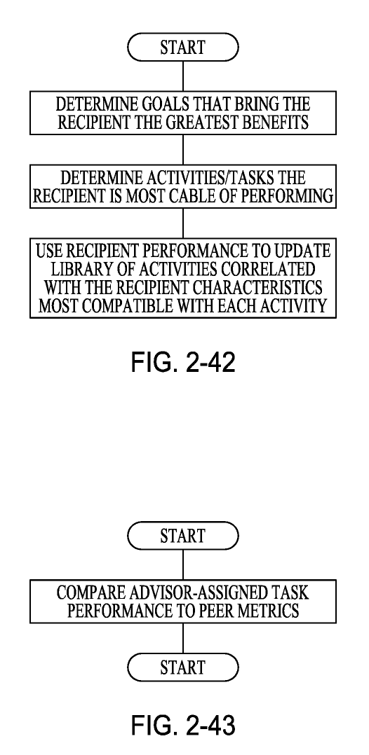

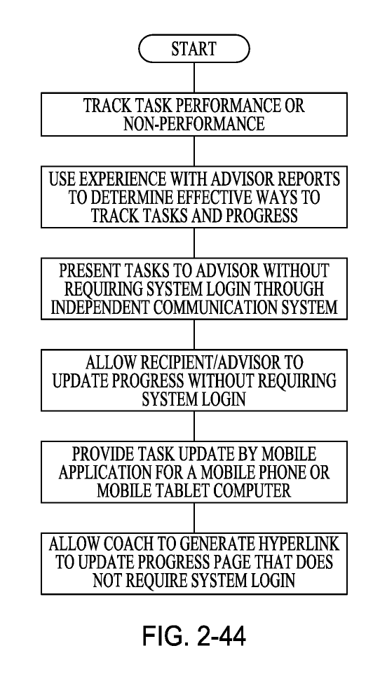

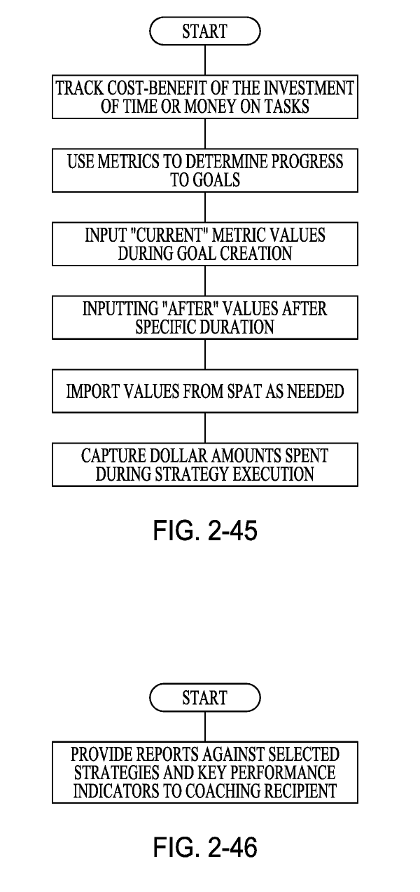

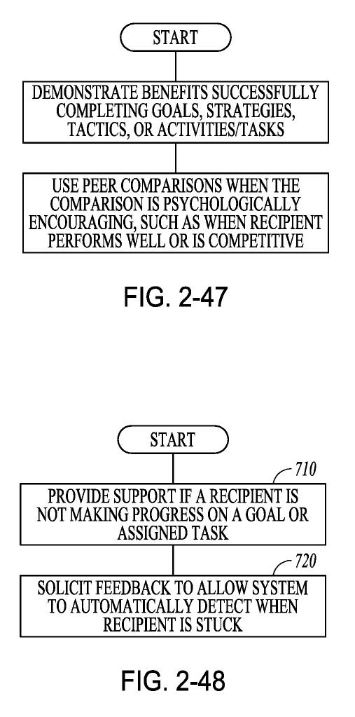

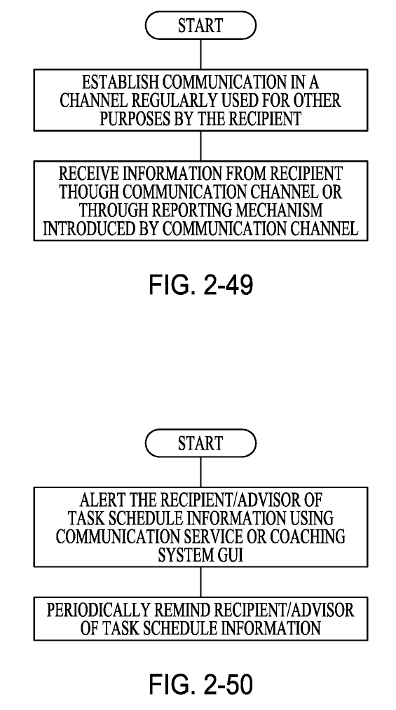

As illustrated in the overview of FIG. 1-1, the system further includes one or more computer program components 1130 operative on a computing system 1090 including a CPU 1140 capable of executing program instructions, to configure the computing system to: a) operate in one or more modes, wherein each mode provides a different combination of operating capabilities; b) provide the graphical user interface (GUI) 1110; and c) receive input through the GUI 1110 utilizing one or more communications interfaces 1150, to create a recipient-specific goal data unit. As shown in FIG. 1-2 in some examples, the recipient specific data unit includes: i) a working name for the goal 2020; ii) a goal type for the goal 2005 iii) at least one value or parameter for the goal type 2060; iv) one or more obstacles for the goal 2030; and v) one or more personal benefits 2040 for achieving the goal.

In addition, in this example embodiment, as illustrated in FIG. 1-3, the computer assisted coaching system includes one or more computer program components executable to configure the computing system to: a) schedule activities to be performed by the individual based on the goal data unit 3010, wherein the schedule specifies a time or time frame for performance of the tasks: b) track activities performed by an individual based on goal unit data 3020; c) generate reports showing progress against the activities 3030; and d) track progress against the goal being pursued by the individual 3040 and generate reports showing progress against the goal 3030.

Further, in this example embodiment, the computer assisted coaching system includes an interface with one or more communication systems 3050 independent of the system, wherein the one or more communication systems are selected from the group: an e-mail service, an instant message service, a text messaging service, and an electronic calendaring service. Further, the one or more program components execute on the computing system to send communications through the interface and the one or more independent communication systems to the recipient. According to one example embodiment, the communications to the recipient include one or more of the following communications obtained from the recipient-specific goal data unit: a) one or more reminders or instructions to perform tasks associated with the type of goal; or b) one or more reasons for achieving the goal; c) one or more obstacles to achieving the goal; and d) one or more authorities for why the activities to be performed are effective for achieving the tactic, and accordingly the objective and goal.

Furthermore, as illustrated in FIG. 1-4, the system is configured by the one or more computer programs to receive communications through the interface 4010 and the independent communication systems from the recipient of the coaching, wherein the communications from the individual originate from one or more of the independent communication systems and include one or more of the following: a) one or more reports from the individual regarding the performance or nonperformance of tasks associated with the type of goal specified in the goal data unit; and/or b) one or more reasons why the tasks were not performed, and/or performed, in a timely fashion.

According to one example embodiment illustrated in FIG. 1-5, the coaching system includes a first interface 5010 that is adapted to creating and defining goal data units specifically for a particular coaching recipient. For the purpose, the system includes a private, independent account for each coaching recipient, and the recipient-specific goal data units are associated with one or more, but typically only one, account for the coaching recipient. The first interface provides a GUI that is used by a system user, which may or may not be the coaching recipient, to create and define a goal data unit 5020 for a user. Using this interface, an example of which is described in more detail below, a user can interact with structured, e.g. work-flow enabled, GUI to select predefined choices created for each of the following inputs to a goal data unit: a) choose a type of goal, and specify (input by soft or hard keypad) a user-specified name for the goal); b) select and/or specify a value, parameter or metric to achieve for the goal, from a predetermined or predefined set of options (such as a percentage to increase performance, or a value to attain to increase performance); c) select and/or specify a particular strategy to achieve the goal from a predetermined or predefined set of options; d) select and/or specify a particular objective/tactic to achieve the strategy from a predetermined or predefined set of options; e) select and/or specify a particular type of activity to achieve the objective/tactic from a predetermined or predefined set of options; f) select and/or specify more reasons for achieving the goal from a predetermined or predefined set of options; g) select and/or specify one or more obstacles to achieving the goal from a predetermined or predefined set of options; and h) optionally specify baseline data for a level of past performance against which future improvement in performance can be measured. In one example embodiment, only predefined or system determined choices are offered to the user when creating a goal data unit for a coaching recipient. In another example embodiment, the user can create new types of goals, new types of strategies, new types of objectives/tactics, and new types of activities, and add those to the system's predefined or predetermined choices for the same or other users in the future.

As illustrated in FIG. 1-6, the system further includes an assessment module 6010 that is used to collect information 6030 on the preferences, capabilities, biases, predilections, life goals, hopes, family objectives and other characteristics of a coaching recipient, which is stored in a recipient data structure or profile 6020. This data can be used for the purpose of assisting in the coaching of the recipient, in the creation of goal data structures for the recipient, and for delivering coaching and handling coaching interactions. For example, in one example embodiment, the system offers choices in the goal creation process illustrated with respect to FIG. 1-5 based on at least in part the personal profile established by the assessment module.

Referring now to FIG. 1-7, there is illustrated the configuration and operation of the coaching module or engine 7000 of the computer system for using, modifying and adding to the data structures described above for the purpose of coaching a coaching recipient, wherein the configuration and operation is achieved with the one or more computer program components. As illustrated in FIG. 1-7, the coaching module 7000 is responsive to a recipient-specific goal data structure includes the ability to: a) schedule activities 7010, or more specifically tasks, to be performed by the individual based on the goal data unit, wherein the schedule specifies a particular date and time or date/time frame, for example optionally with or in the alternative a deadline, for performance of the tasks; b) track activities performed by the recipient 7020, c) determine compliance or non-compliance, i.e. success or failure in completing assigned activities 7030; d) report on compliance/non-compliance with respect to assigned activities 7040; e) determine progress against the goal, or the strategy, or the tactic being pursued by the recipient 7050; f) report on progress against the goal, or the strategy, or the tactic being pursued by the recipient 7070, and g) optionally adjust the goal dynamically if the progress is below a threshold either predetermined prior to starting work on the goal, or determined dynamically as the goal is being pursued 7060.

According to one example embodiment, illustrated in FIG. 1-8, the one or more communication systems independent of the system are selected from the group: an e-mail service 8010, an instant message service 8030, a text messaging service 8020, and an electronic calendaring service 8040. According to another example embodiment, the communication systems independent from the recipient are communication systems or services that have general utility for the user and are used for various types of communications such as general business or general pleasure, and are not dedicated to use for interacting or communicating with the coaching system. Accordingly using these independent systems to communicate with the recipient, the recipient can receive coaching and send feedback and reports to the coaching system all without directly using a coaching system interface, such as by visiting a coaching web site, running a coaching program on their hand held, mobile, laptop or desk-top computer. In one alternative, the messaging service may be integrated as part of program, web interface or utility used by the coaching recipient for other purposes, such as a mobile social media app (e.g., a Facebook® app), or a social media web site 8050. In still another embodiment, the coaching recipient does not need to log on to a web site or application, or install any application dedicated for the coaching system.

Referring now to FIGS. 2-1 to 2-40, there is illustrated a first example embodiment of a GUI for use by users seeking to administer or use the system described above. In the example embodiment of the GUI described hereinafter, the coaching system is adapted to coach individuals at a financial planning practice. The system, however, may also be applied to coach individuals to achieve other types of educational, vocational, career, business, athletic or any other type of goal. However, the system is particularly adapted in this embodiment for an individual to attain a business goal. GUI A 21000 is a manager dashboard that allows a manager or other administrator to establish accounts for coaching recipients that belong to individual financial planning practices, and provides access to logins and recipient-specific goals, referred to as “Roadmaps” in the example GUI herein. The Roadmaps or goals are associated with individual practices. The GUI A also provides access to aggregate metrics for Roadmap objectives and usage. GUI A is, in this example embodiment, the main manager dashboard screen. As illustrated in FIG. 2-2, Roadmap users and data are organized by “keys.” Each coach has access to his or her own key and may have access to other coaches' keys, as appropriate. Coaches may, in one example embodiment, only be able to see the keys that they have access to. In addition to organizing and limiting access to coaching recipients, in this case financial advisors, the access key functionality allows the user to view data on the manager dashboard by individual keys or combinations of keys. To filter a manager dashboard by key, go to the “Access Keys” tab 22000 and select or de-select keys and click on “Save Changes.”

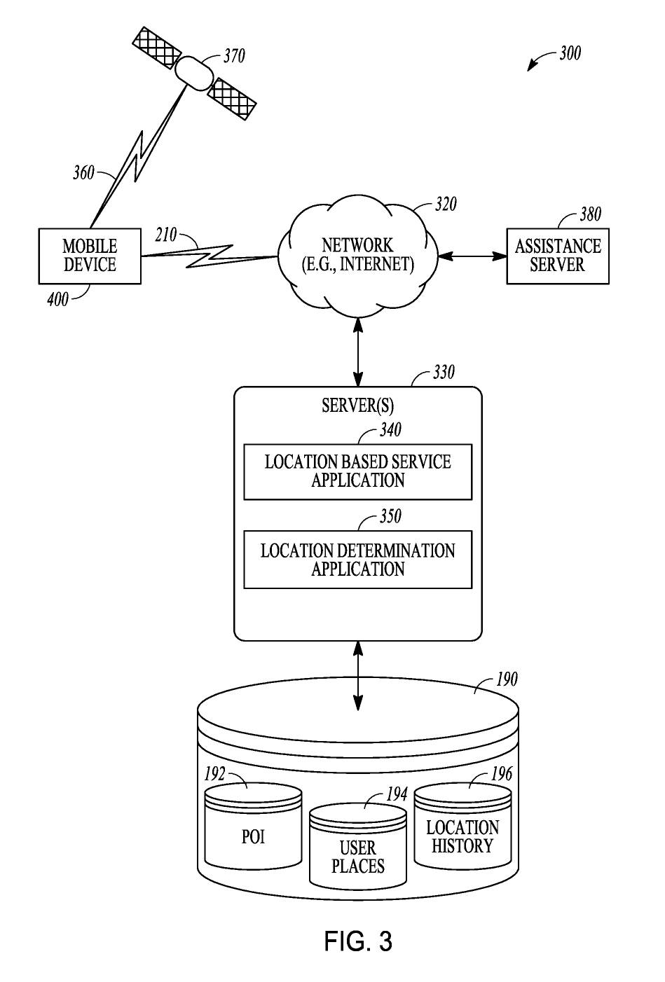

As shown in the GUI of FIG. 2-3, the “Summary” section 23000 of the manager dashboard is used to log in as an existing user, or to create a new user. To log in as an existing advisor, a user selects the advisor from the list 23005 and clicks the “Login” link 23010—a new browser window is launched and the user is logged in on behalf of the advisory firm.

As shown in the GUI of FIG. 2-4, to set up a new user in Roadmap, the user employs the “Create New User” tab 24000. The user selects the access key (e.g., using drop down menu 24010) in which the practice should be included, assigns a username, and clicks “Create” 24030, then goes back to the “Login As User” tab 24040, selects the new username and clicks the “Login” link—a new browser window is launched and the user is logged in on behalf of the new advisory firm.

The GUI of FIG. 2-5 illustrates a shortcut to find recently created roadmaps. By clicking on the column headings (25000-25030), the user can sort by the name of the saved Roadmap report, the name of the firm, the path of the Roadmap, or the date the Roadmap was created. The user can also use the search capabilities of this section by entering key word(s) in the text box 25040 next to “Search.”

The GUI's of FIGS. 2-6 to 2-9 is the “Reporting” tab of the Manager Dashboard, where the user can view which Roadmap high, medium or low level objectives the advisors are selecting, wherein high level objectives are high level goals as defined above, mid level objectives are strategies, and low level objectives are tactics, as those terms are used hereinabove. The user can drill down from high-level objectives to mid-level objectives to detailed-level objectives. This will help the user, in this example a coach for the advisors, to focus on the business needs that are most common among the advisors the user/coach support. In the GUI view of FIG. 2-6, the user can see that “Growth” 26010 is the most common high-level business objective.

By clicking on the bar 26020 above “Growth” (or using the Drill Down menu 26030) the user get to the screen of FIG. 2-7, which shows the user which mid-level objectives under “Growth” were selected by advisors or users setting up goals (27000-27030). In this example, “Increase AUM” 27000 is the most common mid-level growth objective.

By clicking on the bar above “Increase AUM” 27040 (or using the Drill Down menu 27050) the user gets to the GUI of FIG. 2-8, which shows the user which detailed-level objectives 28000-28020 under “Increase AUM” were selected. In this example, “Increase AUM from Existing Clients” 28000 is the most common detailed-level objective.

Another view of the mid-level objectives is available in the “Roadmaps by Goal” report 29000 on the lower-half of the screen. The report shown in the GUI of FIG. 2-9 gives the top high-level/mid-level objective combinations 29010 that were selected.

The “Reporting” tab of the Manager Dashboard also gives the user insight into Roadmap usage 200. The report of FIG. 2-10 displays Roadmap usage by month 202. The report details the number of logins, new Roadmap reports created, and Progress Updates created each month. Another usage report 204 shown in FIG. 2-11 provides information by Access Key. This report displays new Roadmaps and Roadmap updates by Access Key for the date range 206 selected at the top.

The GUI of FIG. 2-12 shows the “Client Details” 210 tab. This tab shows a summary of client firms and profile information. From here, it is possible to view each advisor's Roadmaps by clicking on any of the clients 212 listed on the screen.

As shown in FIG. 2-13, by clicking on the firm “TJ & Associates,” 214 (FIG. 2-12) the user can view the five Roadmaps 218 this firm has created.

Set forth below is a description of a method for using the GUI and system to create a new advisor user. The method includes, as shown in FIGS. 2-14 to 2-17:
1. From the Manager Dashboard “Summary” tab, navigate to the “Create New User” sub-tab 220.
2. Select the appropriate Access Key 222.
3. Create a unique user name 224.
Please note that the user should only have one login ID per practice. The user might create Roadmaps with different members of a firm (e.g. CEO and Operations Manager), but they will all be created and saved under the same login.
4. Select the “Create” link 226. The system will auto-generate a password for the user, which the user will not see—this password will not need to be recorded nor remembered as the user will login on the advisor's behalf from the manager dashboard.
5. Once the user has created the new firm, navigate to the “Login As User” 228 sub-tab.
6. Select the new user 230 based on the username the user created in the previous step (it should be at the bottom of the list, but the user can sort alphabetically by selecting the column title).
7. Click the “Login” link 232—the system will launch a new Roadmap session for the user in a separate window (based on browser settings). We strongly recommend that the browser be set to launch a new window, so that when the user use a web conference system, the user can configure the presentation to display a clean version of the advisory firm's Roadmap session.
8. From the new browser window, the user is prompted to complete 234 the “User Profile.”
9. Click the OK button 236, and the browser is directed to the Profile screen.
10. Go through the Profile sections 240 and complete each section.
11. User Password—the user can create a password for the user in this section as well. Click the “Login” link 242 on the left side of the screen and the user is directed to the section where the user can create a password for the user. Click “Change Password” to activate the password fields.
12. When registration is completed, the user is directed to the Roadmap creation screens. The user can also logout and close the browser window, and log in on behalf of the user at a later time.

FIGS. 2-18 to 2-23 illustrates a method of Creating a new Roadmap for an advisor using the GUI and system, as follows:
1. From the manager dashboard 245, select the advisor with which the user wish to work, and click the “Login” link 247. The user will then be logged-in on behalf of that advisory firm.
2. Prior to sharing the screen, perform the actions to ensure that the user presents only the advisory version of Roadmap, and not the manager dashboard or other applications with client data:
   a. From the web conference session share only the immediate browser window with the Roadmap version for the current advisory firm.
   b. Make sure that the manager dashboard is minimized, or close the window altogether.
3. Once the user is sharing the screen with the advisor, select the “Create New Roadmap by Objective” link 252 from the home page 250.
4. Guide the user through a Roadmap path based on the assessment of their needs. In the following example, we are focusing on profit by growing revenue through acquiring more clients. Choose a High-Level 260, Mid-Level 262, and Detailed Business Objective 264. Click “Next” 266 when complete.
5. Define a goal with the client 275. The goal is tied to the mid-level objective. Specific recommendations will determine which key activities the advisor will pursue to increase the likelihood of achieving the goal. Click “Next” 277 when the goal has been defined.
6. Determine which recommendations 280 the advisor should implement to maximize the possibility of achieving his or her goal. At this point it is critical that the advisor agrees to carry out the specific recommendations. If the goal the advisor sets is not in alignment with the actions he or she is prepared to take, work with the advisor to look for alternatives (e.g. outsourcing, consultants, etc.) or reset the goal to a more achievable metric.
7. Each recommendation has a milestone 284, and in some cases, a metric assigned to it. As with goals, help the advisor set realistic targets. Make sure the user set a milestone and metric (if available) for each recommendation that was selected. When complete, select “Generate Report” 286.
8. Once the user has selected “Generate Report” the user is prompted to enter a unique name for the Roadmap report. We recommend the user select a name the user can reference easily in the future and describes the Roadmap's objective such as “Grow Client Base Q2 2008”.
9. After entering a report name and selecting “Save,” the Roadmap screen is redirected to the advisory firm dashboard and a new pop-up of the report is generated.
10. Read through the report with the client and determine if the user would like to send them a copy in PDF or RTF format.

Referring now to FIGS. 2-24 to 2-27, there is illustrated a method to review an existing Roadmap with an advisor, according to one example embodiment, including:
1. From the manager dashboard, select the user 290 and click the “Login” link 292 at the bottom of the screen—a new browser session is launched, and the user is logged-in on behalf of the advisory firm.
2. Once the user is sharing the screen with the advisor, select the “Your Roadmap Dashboard” link 294 from the advisory firm home page.
3. From the “Roadmaps” tab 298 the user can see the existing Roadmaps 300 for this user, and select the one the user wish to review. The user can also choose the following actions:
   a. View the Roadmap report that was created
   b. Launch a PDF or RTF version of the report
   c. Rename the Roadmap report
   d. Add or remove recommendations from the Roadmap report
4. Select the “Goal Progress” tab 304 to review goals and metrics, and to record updates on progress towards the goal and recommendations. From here, the user can do the following:
   a. Update goal and recommendation progress using the “Overall Goal Progress” and “Metrics & Milestones” sub-tabs 304.
   b. Alter key attributes (e.g. date or dollar amount) of goals and metrics

FIGS. 2-28 and 2-29 illustrate a GUI 308 for showing progress history. Each time the user update the progress of an advisor's Roadmap in the “Goal Progress” tab, the information is saved as a separate entry. In the screen shots below, the user will notice the Roadmap called “Grow AUM” has two entries, one on June 4th 312 and another on June 8^{th} 310. Notice that the information on the right-hand side of the screen 314 is different for the entry on June 4th (first screen shot) than the entry on June 8th (second screen shot) 316.

Note, in one example embodiment, the user can only save one entry per day. If the user updates the same Roadmap more than once in the same day, the system will override the earlier information with the most recent changes.

The GUI of FIGS. 2-30 and 2-31 illustrates a business plan generator 320 that allows an advisor to create a business plan using multiple Roadmap reports as well as other information. The business plan generator is located in the advisor Roadmap dashboard under the “Create Plan” tab 320. This GUI and system is used, in one example embodiment, according to the method that includes:
1. Select which Roadmap reports the user would like to include in the Business Plan. The user clicks the check boxes 324 next to the reports the user want to include and click “Next” 326.
2. On the next screen 328 the user can input or select other information to include in the Business Plan. Each enterprise firm that licenses Roadmap will have slightly different options, so the screen shot below is just an example of the options that are typically available.
3. Select “Create” 330 at the bottom of the screen to generate the PDF or RTF report.

FIGS. 2-32 to 2-34 illustrate a GUI for an agenda generator that allows the user to create a meeting agenda using multiple Roadmap reports. The tool is located in the Advisor Roadmap dashboard under the “Create Agenda” tab 332. There are two agenda creation options, a quick agenda 334 and a custom agenda 336. In this example method, the “Quick” Agenda Generator option simply looks for tasks that are due within 7, 14, or 30 days. The “Custom” Agenda Generator option lets the user select which Roadmap reports to include for review in the agenda. In this example method:
1. After selecting the Roadmap reports to include in the agenda 342, the user clicks “Next” 338 and is taken to the screen of FIG. 2-33 344 where the user can choose from a few more options 346 before generating the agenda. The user clicks “Create” 348 to generate the meeting agenda.

FIGS. 2-35 to 2-37 illustrate the GUI of the benchmark module that allows the user to track actual and plan data for the practice and compare the practice to benchmark groups.

The exact configuration of the benchmark module may optionally vary based on the enterprise organization that is using the tool. In some instances, all data entry may be manual and that is the scenario described herein. In other alternate embodiments, there are provided automatic data feeds from external sources. If the configuration of the benchmark module includes data feeds, then the usage of the tool may differ slightly from what is described below.

For the first time the user use the benchmarking module there is a couple of set—up steps to complete, including the following method:
1. The user clicks on Create New Data Entry 350.
2. Next the user is asked to define the time period 352 and type (actual or plan) of entry 354 the user wish to make.
3. The user clicks “Save” 356 to continue.
4. Next the user is directed to the data input form 360 where the user will enter metric information.
5. The user enters the information in the gray input boxes. To move from one section to the next the user clicks on the next horizontal tab of the accordion file (e.g., “AUM/Production Indicators,” “AUM Breakdown,” etc.)
6. When the user is finished with the input, click they click “Save Changes.” 362

As shown in the GUI of FIGS. 2-38 to 2-41, in the benchmark module there are three different reporting tabs. Each tab is designed to give the user views into actual vs. plan, or actual vs. benchmark results. The three sub-tabs in this section of the benchmark module are: Reporting 364, Charting 366 and Custom Comparisons 368.

The reporting tab shown in FIG. 2-38 provides a canned benchmark comparison report 369. To run the report the following method is used:
1. Select the Report Type 372
2. Select Actual results time period 374
3. Select the appropriate benchmark and benchmark time period 376
4. Click “Generate Report” and a PDF comparison report is generated 378

The charting tab 366 shown in the GUI of FIG. 2-39 allows the user to look at actual vs. plan results 380 in a graphical format. The user can chart any metric that is included in the list of metrics for version of Roadmap.

The custom comparisons tab 368 illustrated in the GUI of FIG. 2-40 allows the user to create a custom report using any of the data available in the benchmark module. The user can create up to four comparisons within on report, using the following method:
1. Select the data set to compare against other data sets (this is usually actual results) 384
2. Select up to four (4) additional data sets to compare against 386
3. Select “Create Comparison” to generate a custom report 388
4. Once the report is generated on screen 390, the user can export it to PDF 392

As illustrated in FIGS. 2-42 to 2-50, the system as described herein is used to perform various methods to support computer assisted coaching of coaching recipients. In one example embodiment, as described with respect to the GUI of FIGS. 2-1 to 2-41, the coaching recipients are financial advisors seeking to improve their advisory practices. As shown in flow chart of FIG. 2-42, according to one example, the assessment module is used to assess a financial advisor who is to be a coaching recipient, in order to determine the goals that will bring the advisor the greatest benefits, and determine which activities/tasks the recipient is most capable of or most likely to be successful performing. According to one embodiment, the actual performance of coaching recipients is used to update a library of activities that are correlated with the recipient characteristics most compatible with each activity in the library.

According to the example method of FIG. 2-43, the coaching system is used to compare advisor performance on assigned tasks to metrics for their peers, stored in the coaching system in a performance data structure for each advisor/recipient.

According to the example method of FIG. 2-44, the coaching system is used to track task performance or non-performance, and determine the most effective, or more effective, ways to track tasks and progress, based on experience with advisors in reporting back to the system. The method further includes, in one embodiment, putting a task or task-list in front of advisor without having to login to the coaching system, such as through independent communication systems already used by the coaching recipient for other purposes, such as their e-mail, instant message services, text message services (such as Twitter), or social media services the recipient uses for other communications. According to this method, the system further provides for ways a recipient/advisor to update progress without having to login. According to one embodiment, the task update may alternatively be provided by a mobile app for a mobile phone or a mobile tablet computer, such as an iPhone® mobile phone or iPad® tablet, sold by Apple Corporation, or similar products using the Android® operating system. In some example embodiments, the method provides for a coach to generate updated roadmap links, for a weekly email link that goes straight to update page with auto login or anonymous login.

According to the example method of FIG. 2-45, the method tracks the cost-benefit of the investment of time or money on tasks. The method provides for using metrics to determine progress to goals when possible. In particular, the method in one example embodiment includes inputting “current” metric values during goal creation, and inputting “after” values once a given amount of time has passed. The method further captures the dollar amounts spent during strategy execution, for example when the recipient clicks complete on the last of their tasks.

As illustrated in the method of FIG. 2-46, there are provided to the coaching recipient from time to time or regularly, reports against selected strategies and key performance indicators.

As illustrated in the method of FIG. 2-47, the method and system are used to drive behavioral change or performance by demonstrating in one or more ways the benefits of working on the goal, such as highlighting the benefits of successfully completing goals and/or strategies and/or tactics and/or activities/tasks. Such benefits may be provided by “In-app” visuals, in the case where an app is deployed for use by the coaching recipient. Alternatively, peer comparisons are used, particularly where the comparison is psychologically encouraging for the recipient, such as when the recipient is performing as well or better than peers, or is highly competitive.

As illustrated in the method of FIG. 2-48, the method and system are used to drive behavioral change or performance by providing support if an advisor/coaching recipient is “stuck”, i.e., not making progress on a goal or sub-goal initiative, most particularly assigned tasks. According to one example embodiment, the method includes soliciting feedback from the recipient/advisor that allows for the system to automatically detect or determine, as quickly as possible, when the recipient is stuck.

As illustrated in the method of FIG. 2-49, the method and system are used to communicate with the recipient/advisor using the communication service or other tools (for example as described above) already used by the recipient for other purposes, in order that communication can be established in a channel that the recipient already regularly interacts with. Interaction on this communication service or tool includes receiving information and updates from the recipient through the service or tool, or through a reporting mechanism integrated or introduced by the service or tool, such as a hyperlink to an automated login service.

As illustrated in the method of FIG. 2-50, the method and system are used to communicate with the recipient/advisor using the communication service or other tools, or in the alternative directly through a coaching system GUI, for the purpose of alerting the recipient/advisor that task execution is required or scheduled at a particular time, or to be performed in a particular time frame. Alerts for example may be sent in real time, hourly, daily or weekly, to name a few but not an exhaustive list of possibilities.

### Example Operating Environment

FIG. 3 is a block diagram illustrating an environment 300 for operating a mobile device 400, according to an example embodiment, for deploying and/or implementing the coaching system and methods described herein. The mobile electronic device 400 may be any of a variety of types of devices, for example a cellular telephone, a personal digital assistant (PDA), a Personal Navigation Device (PND), a handheld computer, a tablet computer, a notebook computer, or other type of movable device. The device 400 may interface via a connection 310 with a communication network 320. Depending on the form of the mobile electronic device 400, any of a variety of types of connections 310 and communication networks 320 may be used. The device 400 may further interface with a satellite 370 via a link 360.

For example, the connection 310 may be Code Division Multiple Access (CDMA) connection, a Global System for Mobile communications (GSM) connection, or other type of cellular connection. Such connection 310 may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, or other data transfer technology. When such technology is employed, the communication network 320 may include a cellular network that has a plurality of cell sites of overlapping geographic coverage, interconnected by cellular telephone exchanges. These cellular telephone exchanges may be coupled to a network backbone, for example, the public switched telephone network (PSTN), a packet-switched data network, or to other types of networks.

In another example, the connection 310 may be Wireless Fidelity (Wi-Fi, IEEE 802.11x type) connection, a Worldwide Interoperability for Microwave Access (WiMAX) connection, or another type of wireless data connection. In such an embodiment, the communication network 320 may include one or more wireless access points coupled to a local area network (LAN), a wide area network (WAN), the Internet, or other packet-switched data network.

In yet another example, the connection 310 may be a wired connection, for example an Ethernet link, and the communication network may be a local area network (LAN), a wide area network (WAN), the Internet, or other packet-switched data network. Accordingly, a variety of different configurations are expressly contemplated.

A plurality of servers 330 may be coupled via interfaces to the communication network 320, for example, via wired or wireless interfaces. These servers 330 may be configured to provide various types of services to the mobile electronic device 400. For example, one or more servers 330 may execute location based service (LBS) applications 340, which interoperate with software executing on the device 400, to provide LBS's to a user. LBS's can use knowledge of the device's location, and/or the location of other devices, to provide location-specific information, recommendations, notifications, interactive capabilities, and/or other functionality to a user. Knowledge of the device's location, and/or the location of other devices, may be obtained through interoperation of the device 400 with a location determination application 350 executing on one or more of the servers 330. Location information may also be provided by the device 400, without use of a location determination application, such as application 350. In certain examples, the device 400 may have some limited location determination capabilities that are augmented by the location determination application 350. The servers are coupled to database 190, which includes point of interest files 192, user place files 194, and location history files 196.

### Example Mobile Device

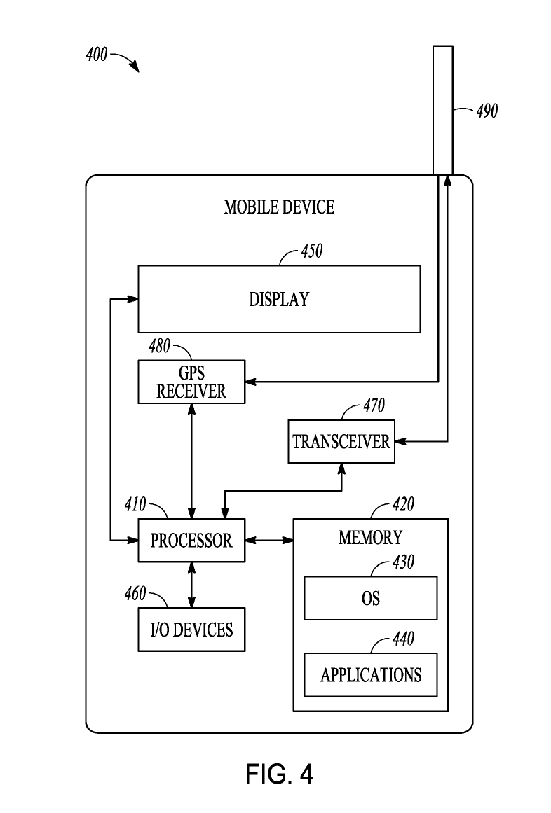

FIG. 4 is a block diagram illustrating the mobile device 400, according to an example embodiment, for deploying and/or implementing the coaching system and methods described herein. The device 400 may include a processor 410. The processor 410 may be any of a variety of different types of commercially available processors suitable for mobile devices, for example, an XScale architecture microprocessor, a Microprocessor without Interlocked Pipeline Stages (MIPS) architecture processor, or another type of processor. A memory 420, such as a Random Access Memory (RAM), a Flash memory, or other type of memory, is typically accessible to the processor. The memory 420 may be adapted to store an operating system (OS) 430, as well as application programs 440, such as a mobile location enabled application that may provide LBS's to a user. The processor 410 may be coupled, either directly or via appropriate intermediary hardware, to a display 450 and to one or more input/output (I/O) devices 460, such as a keypad, a touch panel sensor, a microphone, etc. Similarly, in some embodiments, the processor 410 may be coupled to a transceiver 470 that interfaces with an antenna 490. The transceiver 470 may be configured to both transmit and receive cellular network signals, wireless data signals, or other types of signals via the antenna 490, depending on the nature of the device 400. In this manner, the connection 410 with the communication network 420 may be established. Further, in some configurations, a GPS receiver 480 may also make use of the antenna 490 to receive GPS signals.

### Example Platform Architecture

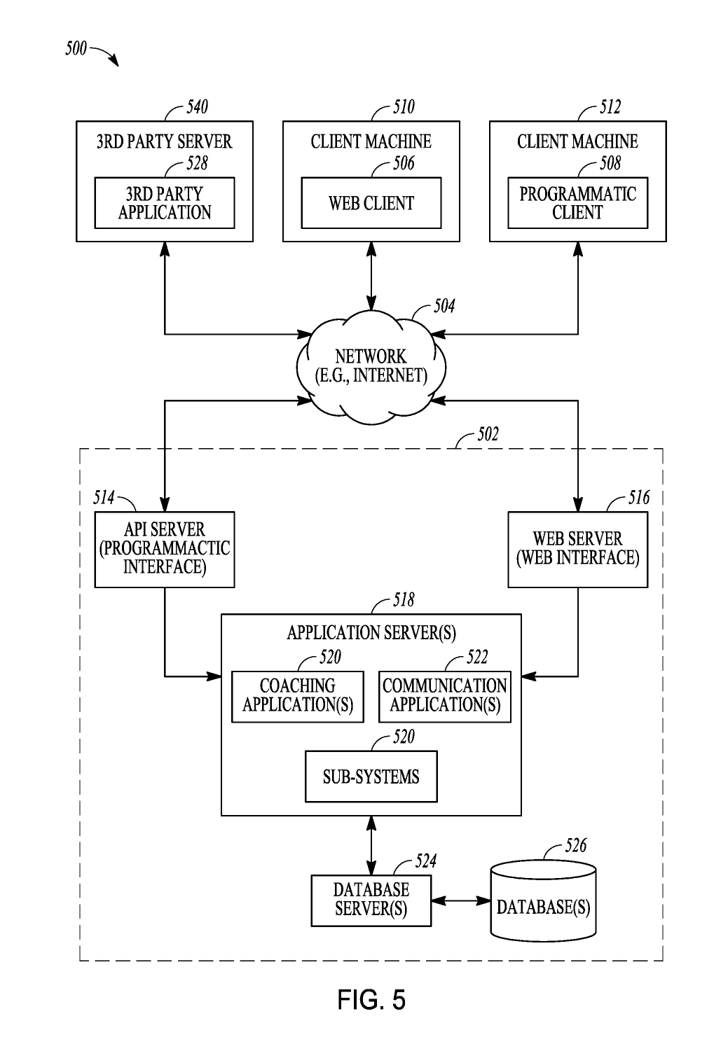

FIG. 5 is a block diagram illustrating a network-based system 500 for deploying and/or implementing the coaching system and methods described herein. In an embodiment, the system operates in real time or near real-time. The block diagram depicting a client-server system 500, within which an example embodiment can be deployed is described. A networked system 502, in the example forms a network-based coaching system, provides server-side functionality, via a network 504 (e.g., the Internet or Wide Area Network (WAN)) to one or more clients 510, 512. FIG. 5 illustrates, for example, a web client 506 (e.g., a browser, such as the Internet Explorer browser developed by Microsoft Corporation of Redmond, Wash. State), and a programmatic client 508 (e.g., WHERE smartphone application from Where, Inc. of Boston, Mass.) executing on respective client machines 510 and 512. In an example, the client machines 510 and 512 can be in the form of a mobile device, such as mobile device 400.

An Application Programming Interface (API) server 514 and a web server 516 are coupled to, and provide programmatic and web interfaces respectively to, one or more application servers 518. The application servers 518 host one or more coaching applications 520 (in certain examples these computer program components are those described herein for the coaching system), communication applications 522, and other sub-systems 532. The application servers 518 are, in turn, shown to be coupled to one or more database servers 524 that facilitate access to one or more databases 526. In some examples, the application server 518 can access the databases 526 directly without the need for a database server 524.

The coaching applications 520 may provide a number of coaching functions and services to users that access the networked system 502, as described otherwise herein. The communication applications 522 may likewise provide a number of communication services and functions to users, for example to interface with and send messages and data between various communication applications, including e-mail services, text messaging services, instant messaging services, or other communication services, such as messaging through social media platforms. While the coaching applications 520 and communication applications 522, and other sub-systems 532 are shown in FIG. 5 to all form part of the networked system 502, it will be appreciated that, in alternative embodiments, the applications 520 and 522 or others may form part of a service that is separate and distinct from the networked system 502.

Further, while the system 500 shown in FIG. 5 employs a client-server architecture, the present invention is of course not limited to such an architecture, and could equally well find application in a distributed, or peer-to-peer, architecture system, for example. The various applications 520, applications 522, and sub-system 532 could also be implemented as standalone software programs, which do not necessarily have networking capabilities.

The web client 506 accesses the various coaching applications 520, communication applications 522, and optional sub-systems 532 via the web interface supported by the web server 516. Similarly, the programmatic client 508 accesses the various services and functions provided by the applications, servers 520, 522 and 532 via the programmatic interface provided by the API server 514. The programmatic client 508 may, for example, be a local recommendation smartphone application (e.g., the WHERE application developed by Where, Inc., of Boston, Mass.) to enable users to receive real-time location-aware merchant promotions on their smartphones leveraging user profile data and current location information provided by the smartphone.

FIG. 5 also illustrates a third party application 528, executing on a third party server machine 540, as having programmatic access to the networked system 502 via the programmatic interface provided by the API server 514. For example, the third party application 528 may, utilizing information retrieved from the networked system 502, support one or more features or functions on a website hosted by the third party. The third party website may, for example, provide one or more functions that are supported by the relevant applications of the networked system 502.

### Modules, Components and Logic

Certain embodiments are described herein as including logic or a number of components, modules, or mechanisms. Modules may constitute either software modules (e.g., code embodied on a machine-readable medium or in a transmission signal) or hardware modules. A hardware module is a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired) or temporarily configured (e.g., programmed) to operate in a certain manner and/or to perform certain operations described herein. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiples of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation, and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures require consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

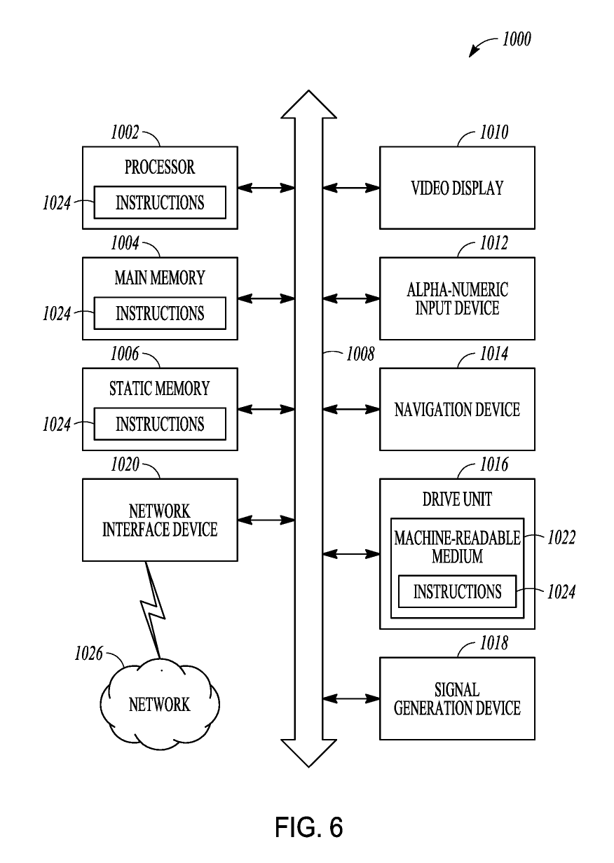

FIG. 6 is a block diagram of a machine in the example form of a computer system 1000 within which instructions, for causing the machine to perform any one or more of the methodologies discussed herein, may be executed. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

### Machine-Readable Medium

The disk drive unit 1016 includes a machine-readable medium 1022 on which is stored one or more sets of instructions and data structures (e.g., software) 1024 embodying or used by any one or more of the methodologies or functions described herein. The instructions 1024 may also reside, completely or at least partially, within the main memory 1004 and/or within the processor 1002 during execution thereof by the computer system 1000, the main memory 1004 and the processor 1002 also constituting machine-readable media.

While the machine-readable medium 1022 is shown in an example embodiment to be a single medium, the term “machine-readable medium” may include a single medium or multiple media (e.g., a centralized or distributed database, and/or associated caches and servers) that store the one or more instructions or data structures. The term “machine-readable medium” shall also be taken to include any tangible medium that is capable of storing, encoding or carrying instructions for execution by the machine and that cause the machine to perform any one or more of the methodologies of the present invention, or that is capable of storing, encoding or carrying data structures used by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1024 may further be transmitted or received over a communications network 1026 using a transmission medium. The instructions 1024 may be transmitted using the network interface device 1020 and any one of a number of well-known transfer protocols (e.g., HTTP). Examples of communication networks include a local area network (“LAN”), a wide area network (“WAN”), the Internet, mobile telephone networks, Plain Old Telephone (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Thus, a method and system for computer guided coaching have been described. Although the present invention has been described with reference to specific example embodiments, it will be evident that various modifications and changes may be made to these embodiments without departing from the broader scope of the invention. Accordingly, the specification and drawings are to be regarded in an illustrative rather than a restrictive sense.

Although an embodiment has been described with reference to specific example embodiments, it will be evident that various modifications and changes may be made to these embodiments without departing from the broader scope of the invention. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be used and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Such embodiments of the inventive subject matter may be referred to herein, individually and/or collectively, by the term “invention” merely for convenience and without intending to voluntarily limit the scope of this application to any single invention or inventive concept if more than one is in fact disclosed. Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

All publications, patents, and patent documents referred to in this document are incorporated by reference herein in their entirety, as though individually incorporated by reference. In the event of inconsistent usages between this document and those documents so incorporated by reference, the usage in the incorporated reference(s) should be considered supplementary to that of this document; for irreconcilable inconsistencies, the usage in this document controls.

In this document, the terms “a” or “an” are used, as is common in patent documents, to include one or more than one, independent of any other instances or usages of“at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

1. (canceled)

2. A machine-readable medium that includes instructions for an electronic calendaring system, the instructions, when executed by processing circuitry, cause the processing circuitry to perform operations comprising:
receiving a goal from a user via a user interface;
identifying activities to be completed by a human based on the goal;
creating entries in the electronic calendaring system for each of the activities;
tracking completion of the activities in the electronic calendaring system to find an activity in the activities that was not completed by a time of a corresponding first entry in the electronic calendaring system; and
rescheduling, in response to finding the activity, the activity by creating a second entry at a later time than the first entry for the activity.

3. The machine-readable medium of claim 2, wherein creating the entries in the electronic calendaring system includes:
dividing the goal into goal units; and
selecting a time and duration for the activities based on the goal units.

4. The machine-readable medium of claim 2, wherein identifying the activities includes matching the goal to the activities via a data structure.

5. The machine-readable medium of claim 4, wherein the data structure includes at least one of a name for a goal or a type of a goal which are matched to the goal entered by the user.

6. The machine-readable medium of claim 4, wherein the data structure includes a set of activities.

7. The machine-readable medium of claim 6, wherein the data structure includes a data set of sources of authority for efficacy of activities in the set of activities.

8. The machine-readable medium of claim 7, wherein identifying activities includes filtering the set of activities based on the efficacy of activities and the human.

9. A method for an electronic calendaring system, the method comprising:
receiving a goal from a user via a user interface;
identifying activities to be completed by a human based on the goal;
creating entries in the electronic calendaring system for each of the activities;
tracking completion of the activities in the electronic calendaring system to find an activity in the activities that was not completed by a time of a corresponding first entry in the electronic calendaring system; and
rescheduling, in response to finding the activity, the activity by creating a second entry at a later time than the first entry for the activity.

10. The method of claim 9, wherein identifying the activities includes matching the goal to the activities via a data structure.

11. The method of claim 10, wherein the data structure includes a set of activities.

12. The method of claim 11, wherein the data structure includes a data set of sources of authority for efficacy of activities in the set of activities.

13. The machine readable medium of claim 12, wherein identifying activities includes filtering the set of activities based on the efficacy of activities and the human.

14. A system for an electronic calendaring system, the system comprising:
processing circuitry; and
a memory including instructions that, when the system is in operation, configure the processing circuitry to:
receive a goal from a user via a user interface;
identify activities to be completed by a human based on the goal;
create entries in the electronic calendaring system for each of the activities;
track completion of the activities in the electronic calendaring system to find an activity in the activities that was not completed by a time of a corresponding first entry in the electronic calendaring system; and
reschedule, in response to finding the activity, the activity by creating a second entry at a later time than the first entry for the activity.

15. The system of claim 14, wherein, to create the entries in the electronic calendaring system, the instructions configure the processing circuitry to:
divide the goal into goal units; and
select a time and duration for the activities based on the goal units.

16. The system of claim 14, wherein the instructions configure the processing circuitry to:
track completion of activities over time; and
generate a report of activity completion to track progress towards the goal.

17. The system of claim 14, wherein, to identify the activities, the instructions configure the processing circuitry to match the goal to the activities via a data structure.

18. The system of claim 17, wherein the data structure includes at least one of a name for a goal or a type of a goal which are matched to the goal entered by the user.

19. The system of claim 17, wherein the data structure includes a set of activities.

20. The system of claim 19, wherein the data structure includes a data set of sources of authority for efficacy of activities in the set of activities.

21. The machine readable medium of claim 20, wherein, to identify the activities, the instructions configure the processing circuitry to filter the set of activities based on the efficacy of activities and the human.
